(19) United States
(12) Patent Application Publication
(10) Pub. No.: US 2025/0153104 A1
(43) Pub. Date: May 15, 2025

(54) Method and Apparatus for Mineral Extraction

(71) Applicant: The University of Manchester, Manchester (GB)

(72) Inventors: Sebastian James Allender Leaper, Manchester (GB); Ahmed Abdelkarim, Manchester (GB)

(21) Appl. No.: 18/837,581

(22) PCT Filed: Feb. 10, 2023
(86) PCT No.: PCT/GB2023/050313

§ 371 Date: Aug. 9, 2024

(30) Foreign Application Priority Data
Feb. 11, 2022 (GB) 2201820.4
Feb. 11, 2022 (GB) 2201823.8
Mar. 1, 2022 (GB) 2202830.2

(51) Int. Cl. B01D 61/36; B01D 61/58; B01D 63/04

(52) U.S. Cl. CPC B01D 61/366; B01D 61/58; B01D 63/04; B01D 2311/2626; B01D 2311/2642; B01D 2311/2643; B01D 2313/22

(57) ABSTRACT

A method 30 and an apparatus 31 for mineral extraction. The method 30 comprising providing a solution comprising 40 a plurality of solutes and selectively extracting a mineral from the solution 60 by adsorption to provide a mineral-rich solution. The method further comprises distilling the mineral-rich solution by membrane distillation 80 to increase the concentration of the mineral in the mineral-rich solution and subsequently removing the mineral from the mineral-rich solution 90.

This invention relates to a method and apparatus for mineral extraction. In particular, a method for mineral extraction comprising membrane distillation and a corresponding apparatus.

### BACKGROUND

The increasing global demand for low-emission transportation such as electric vehicles is driving the growth in the market for lithium. Lithium is the core component for batteries of electric vehicles. However, existing processes for lithium extraction, such as by brine mining and hard-rock mining are often unsustainable. These processes are expensive, consume vast quantities of land, water, chemicals and energy and have a low lithium recovery rate. As such, there is a need for low cost and more effective processes for lithium extraction which have a less significant impact on the environment.

Therefore, there has been an emergence of direct lithium extraction processes which seek to reduce the environmental impact of lithium extraction. Direct lithium extraction processes selectively remove lithium directly from a brine without requiring all the other components (e.g. sodium and magnesium) of the brine to be removed first. However, the effectiveness of known direct lithium extraction processes is limited as there are generally low lithium concentrations in the brine prior to the extraction of final lithium containing products such as lithium hydroxide or lithium carbonate. As such, there exists a need to improve upon the processes for the extraction of lithium from brine by direct lithium extraction.

Whilst the increase in global demand for lithium is driving the need to improve lithium extraction processes from a brine, the principles of such processes may also be used more generally for extracting a mineral from a solution comprising that mineral alongside other solutes to enable a range of different minerals to be extracted from solutions such as brine and wastewater from industrial, agricultural or municipal processes.

It is an object of embodiments of the invention to at least mitigate one or more problems associated with known arrangements. In particular, it is an object of embodiments of the invention to provide an improved method and apparatus for extracting a mineral from a solution.

### BRIEF SUMMARY OF THE DISCLOSURE

In accordance with an aspect of the present invention there is provided a method for mineral extraction comprising:
providing a solution comprising a plurality of solutes;
selectively extracting a first mineral from the solution by adsorption to provide a first mineral-rich solution;
distilling the first mineral-rich solution by membrane distillation to increase the concentration of the first mineral in the first mineral-rich solution; and
subsequently removing the first mineral from the first mineral-rich solution.

The method may comprise increasing the concentration of the first mineral in the solution prior to selectively extracting the first mineral from the solution.

The step of increasing the concentration of the first mineral in the solution prior to selectively extracting the first mineral may comprise increasing the concentration of the first mineral in the solution by membrane distillation.

The step of selectively extracting the first mineral may comprise adsorbing the first mineral from the solution onto a material with selective affinity for the first mineral and applying an acidic solution to the material to desorb the first mineral by ion-exchange thereby providing the first mineral-rich solution.

The method may comprise rinsing the material with selective affinity for the first mineral with water after adsorption of the first mineral onto the material and prior to desorption of the first mineral. The water may comprise water extracted from the solution in the step of increasing the concentration of first mineral in the solution.

The step of removing the first mineral from the first mineral-rich solution may comprise crystallising compounds comprising the first mineral and collecting the crystallised compounds. The method may comprise rinsing the crystallised compounds using water removed from the first mineral-rich solution in the step of distilling the first mineral-rich solution by membrane distillation. The method may comprise recovering enthalpy of crystallisation using a heat exchanger.

In certain embodiments, crystallising the compounds may occur on a surface of a membrane used for membrane distillation and wherein the membrane is configured to initiate nucleation of crystals.

The method may comprise adding seed crystals, non-solvents or precipitants to encourage crystallisation of the compounds within the first mineral-rich solution. The method may comprise using temperature control to encourage crystallisation of the compounds within the first mineral-rich-solution.

The step of distilling the first mineral-rich solution by membrane distillation to increase the concentration of the first mineral in the first mineral-rich solution may comprise concentrating the first mineral-rich solution to a supersaturated state.

The step of providing the solution may comprise heating the solution to a temperature from 20 to 90° C.

The method may comprise polishing the first mineral-rich solution to remove other solutes prior to membrane distillation. The step of polishing may comprise adding a precipitate to the change the pH of the first mineral-rich solution or wherein the step of polishing comprises ion exchange or precipitation.

In certain embodiments, the step of distilling the first mineral-rich solution by membrane distillation may comprise providing membrane distillation apparatus comprising:
an outer conduit; at least one inner conduit disposed within the outer conduit; and a plurality of hollow fibre membranes disposed within the at least one inner conduit;
wherein a first fluid passageway is provided between the outer conduit and the at least one inner conduit; at least one second fluid passageway is provided between the at least one inner conduit and the plurality of hollow fibre membranes; and a plurality of third fluid passageways are provided within the plurality of hollow fibre membranes;
wherein each of the plurality of the hollow fibre membranes comprises a hydrophobic material through which vapour and gas is passable such that, during use, a vaporous permeate is separable from a fluid that is within one of the at least one second fluid passageways and the plurality of third fluid passageways; and
wherein the step of distilling the first mineral-rich solution by membrane distillation comprises distilling the first mineral-rich solution using the membrane distillation apparatus.

In certain embodiments, the step of distilling the first mineral-rich solution may comprise feeding the first mineral-rich solution through the plurality of third fluid passageways; and extracting a permeate of the first mineral-rich solution from the at least one second fluid passageway; wherein the vapour pressure in the plurality of third fluid passageways is greater than the vapour pressure in the at least one second fluid passageway. The method may comprise feeding a coolant through the first fluid passageway to condense at least part of the permeate of the feed fluid in the at least one second fluid passageway; wherein the temperature of the coolant is lower than the temperature of the feed fluid. In certain embodiments, the plurality of third fluid passageways may comprise air, a partial vacuum, a vacuum, a porous material or a liquid

In certain embodiments, the step of distilling the first mineral-rich solution may comprise feeding the first mineral-rich solution through the at least one second fluid passageway; and extracting a permeate of the first mineral-rich solution from the plurality of third fluid passageways; wherein the vapour pressure in the at least one second fluid passageway is greater than the vapour pressure in the plurality of third fluid passageways. The method may comprise feeding the permeate of the first mineral-rich solution through the first fluid passageway to condense the permeate of the feed fluid. The method may comprise increasing the temperature and pressure of the permeate of the first mineral-rich solution before feeding the permeate of the first mineral-rich solution through the first fluid passageway. In certain embodiments, the plurality of third fluid passageways may comprise a partial vacuum, a vacuum, or a liquid.

In certain embodiments, extracting the permeate of the first mineral-rich solution from the plurality of third fluid passageways may comprise feeding a sweep gas through the plurality of third fluid passageways.

Feeding the first mineral-rich solution through the at least one second fluid passageway may comprise feeding the first mineral-rich solution at a pressure that is less than the liquid entry pressure of the hydrophobic material of the plurality of the hollow fibre membranes.

In certain embodiments, the method may comprise: selectively extracting a second mineral from the solution by adsorption to provide a second mineral-rich solution; distilling the second mineral-rich solution by membrane distillation to increase the concentration of the second mineral in the second mineral-rich solution; and subsequently removing the second mineral from the second mineral-rich solution.

According to another aspect of the invention there is provided, an apparatus for first mineral extraction comprising:
means for selectively extracting a first mineral from a solution by adsorption to provide a first mineral-rich solution, wherein the solution comprises a plurality of solutes;
means for distilling the first mineral-rich solution by membrane distillation to increase the concentration of the first mineral in the first mineral-rich solution; and
means for removing the first mineral from the distilled first mineral-rich solution.

The means for distilling the first mineral-rich solution by membrane distillation may comprise a membrane distillation apparatus comprising:
an outer conduit; at least one inner conduit disposed within the outer conduit; and a plurality of hollow fibre membranes disposed within the at least one inner conduit;
wherein a first fluid passageway is provided between the outer conduit and the at least one inner conduit; at least one second fluid passageway is provided between the at least one inner conduit and the plurality of hollow fibre membranes; and a plurality of third fluid passageways are provided within the plurality of hollow fibre membranes;
wherein each of the plurality of the hollow fibre membranes comprises a hydrophobic material through which vapour and gas is passable such that, during use, a vaporous permeate is separable from or a gas is combinable with a fluid that is within one of the at least one second fluid passageway and the plurality of third fluid passageways.

At least one inner conduit may comprise a plurality of inner conduits. The outer conduit and/or the inner conduit may comprise an impermeable material. The at least one the inner conduit may comprise a thermally conductive material.

In certain embodiments, the apparatus may comprise: a first collar securable to an end of the outer conduit; a first insert releasably securable to the first collar; and a plurality of first o-rings arranged between the first collar and the first insert, wherein each of the first collar and the first insert comprise a plurality of apertures and the plurality of inner conduits extend through the first collar and the first insert via the apertures; wherein one of the first o-rings surrounds each of the inner conduits; and wherein the first insert is securable to the first collar such that each of the first o-rings are compressed to sealing engage one of the inner conduits.

One of the first collar and the first insert may comprise a groove extending circumferentially around each aperture, the grooves being configured to receive the first o-rings between the first collar and the first insert; and wherein the height of the first o-rings is greater than the height of the grooves.

Each of the first collar and the first insert may comprise a groove extending circumferentially around each aperture, the grooves being configured to receive the first o-rings between the first collar and the first insert; and wherein the height of the first o-rings is greater than the combined height of the grooves in the first insert and the first collar.

The first insert may be releasably securable to the first collar by at least one threaded fastener. The first insert may be releasably securable to the first collar by a plurality of threaded fasteners.

The first collar may be releasably securable to the outer conduit. The first collar may be releasably securable to the outer conduit by at least one threaded fastener. The first collar may be releasably securable to the outer conduit by a plurality of threaded fasteners.

In certain embodiments, each of the plurality of inner conduits may comprises a bundle of hollow fibre membranes disposed therein and each bundle comprises a support configured to secure the hollow fibre membranes together.

The support may be configured to fixedly position the plurality of hollow fibre membranes relative to one another.

The support may comprise a potting material.

In certain embodiments, the apparatus may comprise: a second collar securable to the first collar; a second insert releasably securable to the second collar; and a plurality of second o-rings arranged between the second collar and the second insert; wherein each of the second collar and the second insert comprise a plurality of apertures, each aperture being configured to receive one of the supports so that the plurality of hollow fibre membranes extend through the second collar and the second insert; wherein one of the second o-rings surrounds each of the supports; and wherein the second insert is securable to the second collar such that each of the second o-rings are compressed to sealing engage one of the supports.

One of the second collar and the second insert may comprise a groove extending circumferentially around each aperture, the grooves being configured to receive the second o-rings between the second collar and the second insert; and wherein the height of the second o-rings is greater than the height of the grooves.

Each of the second collar and the second insert may comprise a groove extending circumferentially around each aperture, the grooves being configured to receive the second o-rings between the second collar and the second insert; and wherein the height of the second o-rings is greater than the combined height of the grooves in the second insert and the second collar.

The second insert may be releasably securable to the second collar by at least one threaded fastener. The second insert may be releasably securable to the second collar by a plurality of threaded fasteners.

The second collar may be releasably securable to the first collar. The second collar may be releasably securable to first collar by at least one threaded fastener. The second collar may be releasably securable to first collar by a plurality of threaded fasteners.

In certain embodiments, the apparatus may comprise a cap releasably securable to the second collar.

In certain embodiments, the first collar may comprise an opening configured to allow fluid to enter or exit the second fluid passageways.

In certain embodiments, the cap may comprise an opening configured to allow fluid to enter or exit the third fluid passageways.

In certain embodiments, the outer conduit may comprise at least one opening configured to allow fluid to enter or exit the first fluid passageway.

A surface of the plurality of hollow fibre membranes may be configured to initiate nucleation of crystals.

The apparatus may comprise a potting material configured to fixedly position the plurality of hollow fibre membranes within the at least one inner conduit.

In certain embodiments, the membrane distillation apparatus may comprise a common fluid passageway fluidly connecting an outlet of the first fluid passageway to an inlet the plurality of third fluid passageways. The common fluid passageway may comprise heating means configured to heat fluid in the common fluid passageway.

In certain embodiments, the membrane distillation apparatus may comprise a common fluid passageway fluidly connecting an outlet of the plurality of third fluid passageways to an inlet of the first fluid passageway. The common fluid passageway may comprise a vacuum pump, a fan or a compressor.

The means for selectively extracting the first mineral from a solution by adsorption may comprise at least one adsorption column comprising a material with selective affinity for the first mineral.

The apparatus may comprise means for polishing the mineral-rich solution to remove other solutes.

In certain embodiments, the apparatus may comprise: means for selectively extracting a second mineral from the solution by adsorption to provide a second mineral-rich solution; means for distilling the second mineral-rich solution by membrane distillation to increase the concentration of the second mineral in the second mineral-rich solution; and means for removing the second mineral from the distilled second mineral-rich solution.

In certain embodiments of the above-described method and apparatus the first and/or second mineral may be an alkali metal, an alkali earth metal, a transition metal, a rare earth element or an organic compound. The first and/or second mineral may be lithium, potassium, calcium or magnesium.

### BRIEF DESCRIPTION OF THE DRAWINGS

Embodiments of the invention are further described hereinafter with reference to the accompanying drawings, in which:

FIG. 1 schematically shows a method according to an embodiment of the present invention;

FIG. 2 shows an apparatus according to an embodiment of the present invention;

FIG. 3 schematically shows a sectional side-view of a membrane distillation apparatus according to an embodiment of the present invention;

FIG. 4 schematically shows a cross-section of the apparatus of FIG. 3;

FIG. 5 schematically shows a cross-section of a part of the apparatus of FIG. 3;

FIG. 6 schematically shows a membrane distillation apparatus according to an embodiment of the present invention;

FIG. 7 schematically shows a membrane distillation apparatus according to an embodiment of the present invention

FIGS. 8 and 9 schematically shows a membrane distillation apparatus according to an embodiment of the present invention;

FIGS. 10 and 11 show data from tests for selectively extracting lithium from a brine by adsorption;

FIG. 12 schematically shows an apparatus for testing mineral extraction by membrane distillation; and

FIG. 13 shows data from tests conducted using the apparatus of FIG. 12.

### DETAILED DESCRIPTION

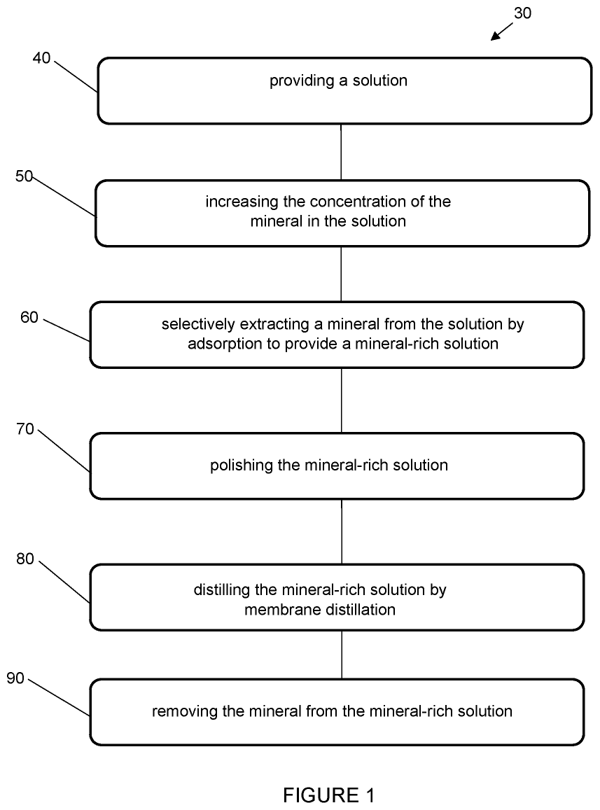

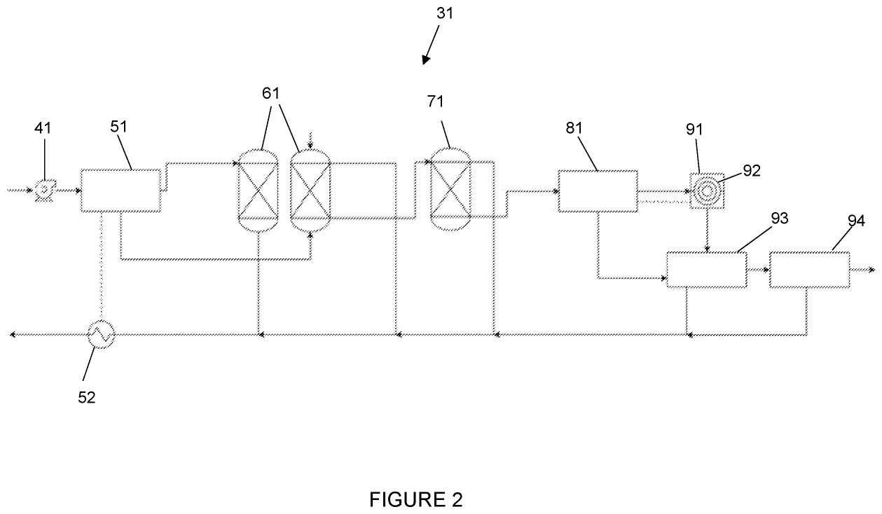

FIG. 1 shows a method 30 for mineral extraction according to an embodiment of the invention. FIG. 2 shows an apparatus 31 for mineral extraction according to an embodiment of the invention which may be used to implement the method 30 of FIG. 1.

The method 30 comprises providing a solution 40 comprising a plurality of solutes. The solution may comprise any liquid which comprises solutes from a plurality of different minerals dissolved within it. Non-limiting examples of the solution include brines such as geothermal brine, brine from a salt-lake or seawater desalination brines, wastewater such as mining, industrial, agricultural or municipal wastewater, or seawater.

The step of providing the solution 40 may comprise heating the solution to a temperature from 20° C. to 90° C. Providing the solution having a temperature in this range may improve the efficiency of mineral extraction from the solution. The solution may be heated by any suitable conventional means. As shown in FIG. 2, the apparatus 31 may comprise heating means 41 configured to receive and heat the solution. The heating means 41 may comprise a heat exchanger. The heat exchanger may be coupled to a heat source. The heat source may comprise any suitable heat source such as a source of low-grade or waste heat such as solar thermal, geothermal or industrial waste heat, thermal gradients in water bodies or a water heater.

The method 30 comprises selectively extracting a mineral from the solution by adsorption 60 to provide a mineral-rich solution. The mineral may be one of the plurality of solutes in the solution. Depending on the content of the solution, the solute may comprise an alkali metal, an alkali earth metal, a transition metal, a rare earth element or an organic compound. For example, if the solution is a brine or seawater the mineral may be lithium, potassium, calcium, magnesium or any other solute in the brine or seawater. If the solution comprises industrial, agricultural or municipal wastewater, the mineral may be an organic compound including but not limited to dyes, pharmaceuticals, Perfluoroalkyl and Polyfluoroalkyl Substances (PFAS) and Perfluorooctanoic acid (PFOA). As such, the mineral is a non-volatile solute of the solution.

In the method, selectively extracting the mineral 60 from the solution may comprise adsorbing the mineral from the solution onto a material with selective affinity for the mineral. This may be achieved by providing one or more adsorption columns 61. In the non-limiting embodiment shown in FIG. 2, the apparatus comprises two adsorption columns 61 each configured to receive the solution. The adsorption columns 61 may comprise a plurality of polymeric spheres which contain the material with selective affinity for the mineral. Alternatively, the adsorption columns 61 may be replaced by an adsorption membrane comprising the material with selective affinity for the mineral (i.e. an affinity membrane). In such embodiments, the adsorption membrane may be configured such that the solution may flow along and/or through the adsorption membrane. To extract the mineral, the solution is caused to flow through the adsorption columns 61 or membrane so that the mineral is adsorbed by the material with selective affinity for the mineral in the plurality of spheres or the adsorption membrane and remains within the columns 61 or membrane. The remaining solution flows out of the adsorption columns 61 or membranes and may be returned to the source of the solution. For example, if the solution is seawater, the apparatus may be configured to return the solution which is not adsorbed by the adsorption columns 61 or membranes to the sea. Once the mineral has been adsorbed by the material, an acidic solution is applied to the material to desorb the mineral by ion-exchange thereby providing the mineral-rich solution.

In certain embodiments, the method may comprise rinsing the material with selective affinity for the mineral with water after adsorption of the mineral onto the material and prior to desorption of the mineral. Rinsing the material may remove any unwanted residue of the solution from the adsorption columns 61 before the mineral is desorbed. The number of unwanted solutes in the mineral-rich solution is therefore reduced.

The material with selective affinity for the mineral and acidic solution are selected depending on the mineral which is extracted from the solution. For example, if the mineral is ionic (e.g. lithium) the material with selective affinity for the mineral may comprise an ion sieve material. If the mineral is lithium, the ion sieve material may be a titanium-based lithium ion sieve material or a manganese based lithium ion sieve. The titanium-based lithium ion sieve material may be based on a Li₂TiO₃ precursor and the manganese based LIS material may be based on a Li_{1.6}Mn_{1.6}O₅ precursor. The titanium-based lithium ion sieve material may, for example, be prepared by grinding a mixture of Li₂CO₃ and TiO₂ (a 2:1 molar Li:Ti ratio) in a pestle and mortar. The powder mixture is then dispersed in ethanol in a sonication bath. The resulting solution is dried at 100° C. to provide a dried powder. The dried powder is thermally treated at 700° C. for 4 hours in an electric furnace to provide the Li₂TiO₃ precursor. This precursor is subsequently de-lithiated by immersing it in a 0.5 M solution of hydrochloric acid (HCl). The solution containing the precursor and HCL is filtered and the remaining powder dried. The dried powder is the titanium-based lithium ion sieve material which may be used in the adsorption columns. For the desorption of lithium following adsorption by the titanium-based lithium ion sieve material, a dilute acid solution such as 0.2 M HCl may be mixed with the titanium-based lithium ion sieve material to provide protons that exchange with the lithium thereby desorbing the lithium. When the mineral is lithium, an acidic solution of hydrochloric acid (HCl) may also be used with different ion sieve materials. The ion sieve material and acidic solution for lithium is not limited to these examples, any suitable material and acidic solution may be used.

If the mineral is a rare earth metal, it may be selectively extracted using different adsorbents as the material with selective affinity for the mineral. Non-limiting examples of suitable adsorbents include zeolites, metal organic frameworks, activated carbon, functionalised activated carbon, functionalised metal oxide nanoparticles (such as TiO₂, SiO₂ or Fe₃O₄) or carbon-based nanomaterials (such as graphene, graphene oxide, functionalised graphene or carbon nanotubes). Selective extraction of rare earth metals may also be achieved via the use of extractants such as crown ethers or chelating agents such as Ethylenediaminetetraacetic acid (EDTA). For example, carboxyl-functionalised activated carbon can be used to adsorb rare earths elements and the rare earth element may be desorbed by an acidic solution of an organic solvents, such as acetone.

If the mineral is an organic compound desorption may be achieved by methods including but not limited to pH adjustment or rinsing with organic solvents.

Performing the selective extraction of the mineral by adsorption is advantageous over alternative processes for selective extraction. Adsorption occurs via diffusion and at low temperatures and pressures. There is no requirement for the solution to be pressurised prior to adsorption. Thus, the adsorption may be more energy efficient than alternative processes for selective extraction. Additionally, adsorption may be more effective than alternative processes because performing the adsorption process once may enable sufficient separation of the mineral from other solutes in the solution. Alternative processes such as nanofiltration may require several stages where each stage is configured to filter out a particular solute. Thus, the complexity and cost of selectively extracting a mineral from a solution may be reduced when using adsorption.

Once the mineral-rich solution has been provided via adsorption, the method comprises distilling the mineral-rich solution by membrane distillation 80 to increase the concentration of the mineral in the mineral-rich solution and subsequently removing the mineral from the mineral-rich solution 90.

As shown in the embodiment of FIG. 2, the apparatus 31 may comprise a membrane distillation apparatus 81. The step of distilling the mineral-rich solution by membrane distillation 80 may comprise providing the membrane distillation apparatus 81. The membrane distillation apparatus 81 comprises a hydrophobic membrane or material through which water vapour and volatile components can pass down a vapour pressure gradient. However, liquid water and the mineral are unable to pass through the membrane from the mineral-rich solution. To distil the mineral-rich solution, the mineral-rich solution contacts a first side of the membrane and a vaporous permeate passes through the membrane to a second side of the membrane. The vaporous permeate comprises volatile components of the mineral-rich solution, non-limiting examples of such volatile components include water. The vaporous permeate may be collected and condensed. The mineral is non-volatile and does not pass through the membrane. Therefore, the concentration of the mineral in the mineral-rich solution on the first side of the membrane is increased by the distillation.

The membrane distillation apparatus 81 may be configured such that mineral-rich solution undergoes one or direct contact membrane distillation (DCMD), air gap membrane distillation (AGMD), sweep gas membrane distillation (SGMD), vacuum membrane distillation (VMD), vacuum-assisted air gap membrane distillation (VA-AGMD), liquid gap membrane distillation (LGMD) or material gap membrane distillation (MGMD). The membrane in the membrane distillation apparatus may be in the form of flat sheets, spiral wound, tubular, or hollow fibre modules.

The hydrophobic membrane may be formed from any suitable material. Non-limiting examples of suitable materials include polymeric and ceramic materials. For example, the hydrophobic material may comprise polyvinylidene fluoride which is a thermally and a chemically stable material. Alternative non-limiting examples for the hydrophobic materials include polyethersulfone, polysulfone, cellulose acetate, nylon, polypropylene, polyethylene, polytetrafluoroethylene and polyacrylonitrile. Additionally, combinations of polymers may be used for the hydrophobic material. In certain embodiments, the hydrophobic material may comprise a material which repels oil or oil-like substances in addition to water. That is, the hydrophobic material may comprise an omniphobic material. The hydrophobic material comprises a plurality of pores through which the water vapour passes. The pore size of the plurality of pores in the hydrophobic membrane may be from 0.1 to 10 microns or from 0.1 to 1 microns.

Once the mineral-rich solution has been distilled by membrane distillation, the mineral may be removed from the mineral-rich solution 90 by crystallising compounds comprising the mineral and collecting the crystallised compounds. To improve the ease of crystallising compounds, the mineral in the mineral-rich solution be concentrated to a supersaturated state when distilling the mineral-rich solution by membrane distillation 80.

The earlier method steps of selective mineral extraction 60 and distillation 80 enables crystals having a high purity of the mineral to be extracted. The size and the quality of the crystals may be of less significance compared to the purity of the crystals because the crystals may be melted prior to any subsequent use. As such, the invention is not dependent on a specific method for crystallising the compounds. Any method for crystallising compounds comprising the mineral may be suitable. Furthermore, distilling the mineral-rich solution by membrane distillation 80 improves the efficacy of removing the mineral from the mineral-rich solution 90 by crystallising the compounds. Membrane distillation is capable of achieving higher concentrations in the mineral-rich solution than is typical of conventional pressure-driven membrane processes. Therefore, allowing greater control of crystallising compounds of the mineral.

Crystallising the compounds may occur within the bulk of the mineral-rich solution or on a surface of the membrane in the membrane distillation apparatus 81. When the compounds are crystallised in the bulk of the mineral-rich solution, this may occur within the membrane distillation apparatus 81. Alternatively, as shown in the embodiment of FIG. 2, the mineral-rich solution may be transferred from the membrane distillation apparatus 81 to a separate crystallisation unit 91 where crystallisation occurs in the unit. To crystallise the compounds in the bulk of the mineral-rich solution, the method may comprise adding seed crystals, non-solvents or precipitants to encourage crystallisation of the compounds on the surface of the membrane. Any suitable seed crystals, non-solvents or precipitants may be used. The seed crystals, non-solvents or precipitants would depend upon the mineral being extracted. For example, if the mineral is lithium and the acidic solution is hydrochloric acid, a precipitate of sodium carbonate may be added. The sodium carbonate would react with the lithium in the mineral-rich (i.e. lithium-rich) solution to produce crystallised compounds of lithium carbonate. Lithium carbonate has low solubility and would therefore be collectable from the mineral-rich solution. Alternatively, the method may comprise using temperature control to encourage crystallisation of the compounds within the mineral-rich solution. For example, the solution may be cooled or heated for facilitate crystallisation of specific compounds within the mineral-rich solution.

When the compounds are crystallised on the surface of the membrane, the membrane in the membrane distillation apparatus 81 may be configured to initiate nucleation of crystals. For example, the membrane surface may initiate heterogeneous nucleation of crystals by providing a low energy surface on which the crystals may form. The compounds then crystallise on the membrane because it is the place in the mineral-rich solution where the concentration of the mineral is highest as it is where the evaporation of water from the mineral-rich solution occurs. Therefore, increasing the area of the membrane surface which contacts the mineral-rich solution helps increase the speed at which the compounds are crystallised. The membrane may also be configured to be resistant to scaling so that the crystallised compounds do not block the pores of the membrane inhibiting distillation and can be removed from the membrane surface by the flow the mineral-rich solution along the membrane surface.

In certain embodiments, the crystal formation may be an exothermic or endothermic process. In such embodiments, the method may comprise recovering enthalpy of crystallisation using a heat exchanger 92. The recovered enthalpy from exothermic reactions may be used, for example, to heat the solution at the start of the method during the step of providing the solution 40. Thus, reducing the energy required for the method. The recovered enthalpy from endothermic reactions may be used to cool a coolant. The coolant may be provided to the membrane distillation apparatus 81 to provide the vapour-pressure gradient for distillation. In the apparatus shown in FIG. 2, the heat exchanger 92 is arranged to recover the enthalpy as crystallisation occurs in the crystallisation unit 91. In alternative embodiments of the apparatus where crystals are formed within the membrane distillation unit, the heat exchanger 92 may be arranged to recover the enthalpy from the membrane distillation apparatus 81.

The crystallised compounds comprising the mineral may be removed from the mineral-rich solution by any suitable solid-liquid separation process. Non-limiting examples of suitable solid-liquid separation processes include filtration, centrifugal separation, gravity settling and crystal substrate removal. After the crystallised compounds, the remaining mineral-rich solution may be returned to the source of the original solution.

Once the compounds have been removed from the mineral-rich solution, the compounds may be rinsed with water. The water may comprise water from the water vapour which was removed from the mineral-rich solution in the step of distilling the mineral-rich solution by membrane distillation 80. The compounds may be dewatered and dried and then collected for a subsequent use.

As shown in FIG. 2, the apparatus 31 may comprise a separation unit 93 configured to receive the crystallised compounds from the crystallisation unit 91. The separation unit 93 provides means for removing the crystallised compounds removed from the mineral-rich solution. The separation unit 93 may be fluidly connected to the membrane distillation apparatus 81 to enable the compounds to be rinsed with water which was removed from the mineral-rich solution during the distillation step 80. The apparatus 31 may comprise a dewatering unit 94 which includes means for dewatering and drying the crystallised compounds. The apparatus 31 may be configured to return the remaining mineral-rich solution, that is the mineral-rich solution after removal the crystallised compounds, to the original source of the solution. The crystallisation unit 91, separation unit 93 and dewatering unit 94 of the apparatus 31 together provide means for removing the mineral from the distilled mineral-rich solution. However, the apparatus is not limited to the embodiment of FIG. 2. The apparatus may comprise any suitable means for removing the mineral from the distilled mineral-rich solution.

Once the mineral has been removed from the mineral-rich solution, it can be then be used in subsequent processes. Extracting a mineral from a solution using the above-described method 30 and apparatus 31, can provide higher concentration ratios, lower electrical energy requirements and better control of crystal production than alternative known methods. Additionally, where there is a natural available source of thermal energy such as large solar irradiance or geothermal heat, the cost of this method can be lower than related technologies such as reverse osmosis.

In certain embodiments, the method may optionally further comprise increasing the concentration of the mineral in the solution 50 prior to selectively extracting the mineral from the solution 60. Increasing the concentration in this way may increase the rate and extent of adsorption of the mineral in the step of selectively extracting a mineral from the solution by adsorption to provide a mineral-rich solution. Membrane distillation, reverse osmosis, electrodialysis, mechanical vapour compression, evaporation, or any other liquid concentration process may be used to increase the concentration of the mineral in the solution 60.

During the step of increasing the concentration of the mineral in the solution 50 prior to selectively extracting the mineral, water is removed from the solution. This water may be used to rinse the material with selective affinity for the mineral after adsorption of the mineral onto the material and prior to desorption of the mineral.

Increasing the concentration of the mineral in the solution 50 prior to selectively extracting the mineral from the solution 60 may be achieved using a concentration apparatus 51. In the apparatus 31 shown in FIG. 2, the concentration apparatus 51 is positioned between the heating means 41 and the adsorption columns 61. The concentration unit 51 may be coupled to a heat exchanger 52. The concentration unit 51 may comprise means for increasing the concentration through membrane distillation, reverse osmosis, electrodialysis, mechanical vapour compression, evaporation, or any other liquid concentration process. If the concentration unit 51 comprises means for increasing the concentration through membrane distillation, the concentration unit 51 may comprise a membrane distillation apparatus having the same configuration as the membrane distillation apparatus 81 used in the method step of distilling the mineral-rich solution by membrane distillation 80. The concentration unit may also be selectively fluidly connected to the adsorption columns so that water extracted from the solution within the concentration unit may be used to rinse the adsorption columns.

In certain embodiments, the method may comprise increasing the concentration of the mineral in the mineral-rich solution after selectively extracting the mineral from the solution 60 and prior to distilling the mineral-rich solution by membrane distillation 80. This may enable the step of distilling the mineral-rich solution by membrane distillation 80 to reach higher concentrations of the mineral in the mineral-rich solution as membrane distillation is particularly effective at high concentrations. Reverse osmosis, electrodialysis, mechanical vapour compression, evaporation, or any other liquid concentration process may be used to increase the concentration of the mineral in the solution after selectively extracting the mineral from the solution 60. In such embodiments, the apparatus may include a concentration unit (not shown) positioned between the adsorption columns 61 and the membrane distillation apparatus 81. The concentration unit may comprise means for increasing the concentration through reverse osmosis, electrodialysis, mechanical vapour compression, evaporation, or any other liquid concentration process. The apparatus may comprise the concentration unit positioned between the adsorption columns 61 and the membrane distillation apparatus 81 in addition to the concentration unit 51 positioned between the heating means 41 and the adsorption columns 61.

In certain embodiments, the method may optionally further comprise polishing the mineral-rich solution 70 to remove other solutes prior to membrane distillation 80 thereby further increasing the purity of the mineral from the mineral-rich solution. This may be advantageous when the mineral is lithium, for example, which will be used in batteries where high levels of purity are required.

The step of polishing may comprise adding a precipitate to change the pH of the mineral-rich solution or the step of polishing may comprise ion exchange or precipitation. As shown in FIG. 2, the apparatus 31 may comprise a polishing unit 71 configured to receive the mineral-rich solution from the adsorption columns. The polishing unit 71 provides means for polishing the mineral-rich solution to remove other solutes. The polishing unit 71 may be configured to receive the precipitate, change the pH of the mineral-rich solution or enable ion exchange.

In embodiments where the mineral is lithium, the pH of the mineral-rich solution may be increased by adding NaOH, Ca(OH)₂ or other sources of alkalinity. During the polishing step, NaOH and Ca(OH)₂ may also be added to reduce the amount of calcium or magnesium in the mineral-rich solution which are considered to be impurities when the mineral for extraction is lithium. Adding NaOH and Ca(OH)₂ cause precipitates of Mg(OH)₂ and Ca(OH)₂ to be produced in the mineral-rich solution. These precipitates are non-soluble and may be removed from the mineral-rich solution by any suitable process. Other additives which may be added during the step of polishing 70 when the mineral is lithium include oxalic acid to precipitate calcium oxalate and/or magnesium oxalate. Alternatively, ion exchange may be used to remove calcium or magnesium by exchanging with them with sodium ions.

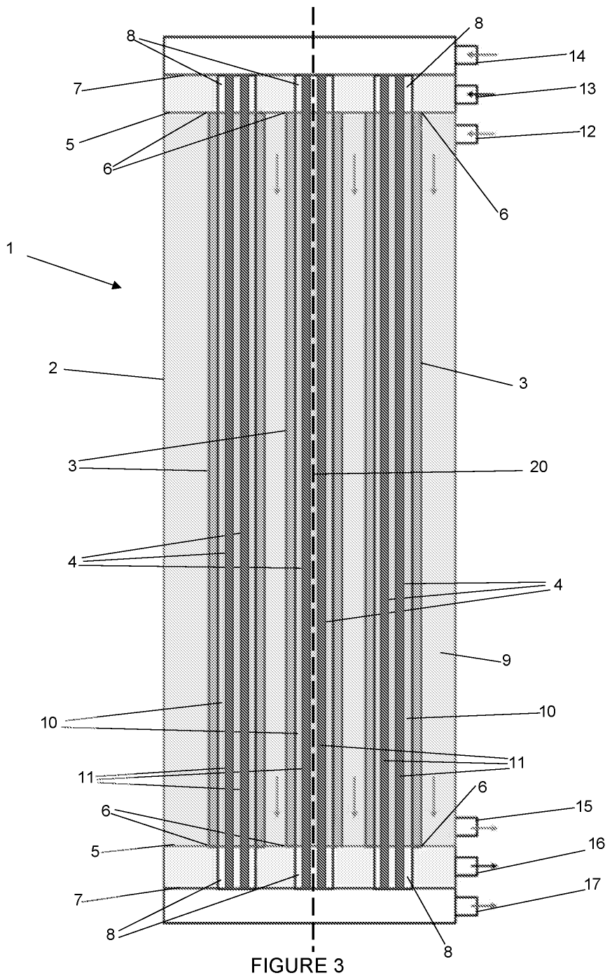

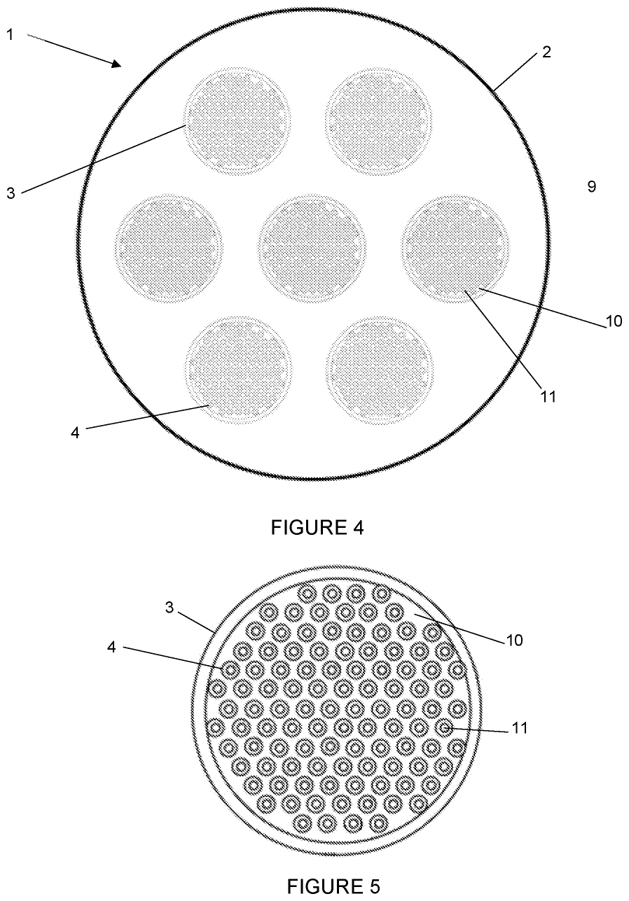

In certain embodiments, the method may use a membrane distillation apparatus as shown in FIGS. 3 to 7 when distilling the mineral-rich solution using membrane distillation 80. Additionally, the membrane distillation apparatus 81 of the apparatus 31 shown in FIG. 1 may comprise a membrane distillation apparatus as shown in FIGS. 4 to 7.

As shown in FIGS. 3 and 4, the membrane distillation apparatus 1 comprises an outer conduit 2. The outer conduit 2 is elongate in shape and has a longitudinal axis 20. In the embodiment shown in FIGS. 3 and 4, the outer conduit 2 is tubular i.e. the outer conduit 2 has a circular cross-section. However, in alternative embodiments, the cross-section of the outer conduit 2 may have a different shape. For example, the cross-section may be hexagonal or rectangular.

The outer conduit 2 may comprise an impermeable material. That is, a material through which fluid cannot pass. Non-limiting examples of suitable impermeable materials include acrylonitrile butadiene styrene (ABS), polypropylene, polyvinyl chloride (PVC), stainless steel and other metallic materials. The outer conduit 2 may be formed from stainless steel or metallic materials when high pressures, for example pressures at or above 10 bar, will be used to separate or combine fluids such as when combing a gas with a liquid.

Within the outer conduit 2, the membrane distillation apparatus 1 comprises at least one inner conduit 3. The inner conduit 3 extends substantially along the length of the outer conduit 2. In the non-limiting embodiment shown in the FIGS. 3 and 4, the membrane distillation apparatus 1 comprises a plurality of inner conduits 3, namely, seven inner conduits 3. However, in alternative embodiments the membrane distillation apparatus 1 may comprise a different number of inner conduits 3. As shown in FIG. 4, the plurality of inner conduits 3 may be uniformly distributed within the outer conduit 2.

Each of the inner conduits 3 of FIGS. 3 and 4 is elongate in shape. A longitudinal axis (not shown) of each inner conduit 3 is parallel to the longitudinal axis 20 of the outer conduit 2. As such, the outer conduit 2 and the plurality of inner conduits 3 are parallel to one another.

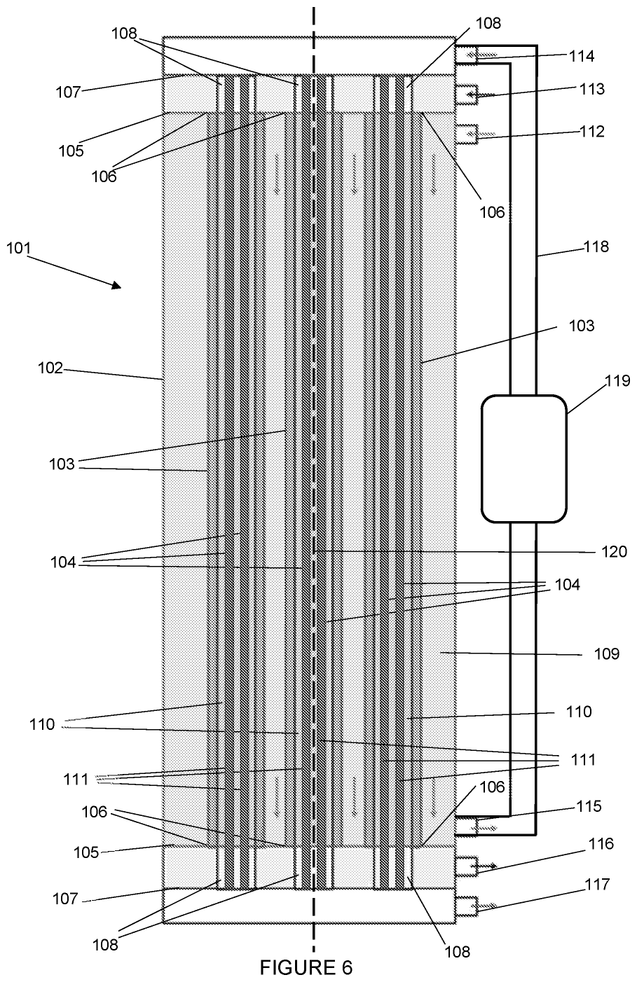

As shown in FIGS. 4 and 5, the plurality of inner conduits 3 are tubular (i.e. the inner conduits 3 have a circular cross-sections). The diameters of all of the inner conduits 3 in the apparatus may be the same as one another. However, in alternative embodiments, the cross-section of the inner conduits may have different shapes and/or may have a range of different sizes. For example, the cross-section may be hexagonal or rectangular and the diameters of the inner conduits may differ from one another.

Each inner conduit 3 may comprise an impermeable material. Each inner conduit 3 may comprise a thermally conductive material. For example, each inner conduit 3 may comprise a graphite-polymer composite. The graphite of each inner conduit 3 may be radially aligned relative to the longitudinal axis of the inner conduit 3 to improve its thermal conductivity. The polymer is included in the composite to reduce the risk of corrosion of the inner conduit 3 during use. Additionally, the polymer may improve the ease of washing off of any crystals that are formed on the inner conduit 3 during use. The polymer used in the composite may depend on the temperatures associated with the intended use of the membrane distillation apparatus. For example, the polymer may comprise polyvinyl chloride (PVC) when the temperature in the membrane distillation apparatus 1 will not exceed 60° C. during use. Alternatively, the polymer may comprise polypropylene (PP) or polyphenylene sulphide (PPS) when the temperature in the apparatus will exceed 60° C. during use.

Within each of the inner conduits 3, the membrane distillation apparatus 1 comprises a plurality of hollow fibre membranes 4. Thus, a bundle of hollow fibre membranes 4 is within each inner conduit 3. As shown in the embodiment of FIGS. 3 to 5, each of the inner conduits 3 may contain the same number of hollow fibre membranes 4. The plurality of hollow fibre membranes 4 may be uniformly distributed within each inner conduit 3.

As shown in the embodiment in FIGS. 3 and 5, each of plurality of hollow fibre membranes 4 may be tubular in shape. The diameters of all of the hollow fibre membranes 4 in the membrane distillation apparatus 1 may be the same as each other. Each hollow fibre membrane 4 has a longitudinal axis which is substantially parallel to the longitudinal axis 20 of the outer conduit 2. As such, the outer conduit 2, the plurality of inner conduits 3 and the plurality of hollow fibre membranes 4 are substantially parallel with one another. In the embodiment shown in FIGS. 3 and 4, each of the plurality of hollow fibre members 4 extends at least along the length of the outer conduit 2 and the plurality of inner conduits 3.

The plurality of hollow fibre membranes 4 comprise a hydrophobic material through which vapour and/or gas is passable during use. As such, vapour and/or gas may pass into or out of the hollow fibre membranes 4 to facilitate the separation of or the combination of fluids within the membrane distillation apparatus 1. In the same manner as the hydrophobic membrane of the distillation apparatus 81 described above, the hydrophobic material comprises a plurality of pores through which the vapour and/or gas pass. The pore size may be from 0.1 to 10 microns or from 0.1 to 1 microns. Alternatively, the pore size may be less than 0.1 microns if a vacuum is applied either inside or outside the plurality of hollow fibre membranes 4 of the membrane distillation apparatus 1 during use. The hydrophobic material may be formed from any suitable material. Examples of suitable materials include polymeric and ceramic materials. For example, the hydrophobic material may comprise polyvinylidene fluoride which is a thermally and a chemically stable material. Alternative non-limiting examples for the hydrophobic materials include polyethersulfone, polysulfone, cellulose acetate, nylon, polypropylene, polyethylene, polytetrafluoroethylene and polyacrylonitrile. Additionally, combinations of polymers may be used for the hydrophobic material. In certain embodiments, the hydrophobic material may comprise a material which repels oil or oil-like substances in additional to water. That is, the hydrophobic material may comprise an omniphobic material.

At each end, the membrane distillation apparatus 1 comprises a first cap 5 configured to fluidly seal the outer conduit 2. The first cap 5 may be welded to the outer conduit 2 to provide a fluid tight seal.

The first cap 5 comprises a plurality of apertures 6. Through each aperture 6, one of plurality of inner conduits 3 extends. Each inner conduit 3 may be welded to its corresponding aperture 6 in the first cap 5 to provide a fluid tight seal.

As shown in FIG. 3, at each end the membrane distillation apparatus 1 also comprises a second cap 7 configured to fluidly seal the plurality of inner conduits 3. The second cap 7 may be welded to the plurality of inner conduits to provide a fluid tight seal. The plurality of hollow fibre membranes 4 extend through at least part of the second cap 7. As shown in the embodiment to FIG. 3, the second cap 7 may also be configured to fluidly seal the plurality of hollow fibre membranes 4. In alternative embodiments, the plurality of hollow fibre membranes 4 may be fluidly sealed by another suitable means. For example, the bundle of hollow fibre membranes 4 in each inner conduit 3 may be fluidly sealed by a separate cap.

As shown in FIG. 3, the plurality of hollow fibre membranes 4 within each inner conduit 3 may be held in a fixed position relative the inner conduit 3 in the second cap 7. The apparatus comprises a potting material 8 to hold each of the plurality of hollow fibre membranes 4 in position. The potting material 8 may comprise a solid cylinder having a plurality of apertures (not shown) through which the plurality of hollow fibre membranes 4 extend. Each of the hollow fibre membranes 5 may be fixed within the plurality of apertures in the solid cylinder by the potting material 8. As such, the hollow fibre membranes 4 may be held in a fixed position relative to the plurality inner conduits 3 at either end of the membrane distillation apparatus 1. The potting material 8 may comprise any suitable material for fixing the plurality of hollow fibre membranes 4 in place. Suitable potting materials include but are not limited to epoxy, polyurethane and silicone adhesives.

The arrangement of the outer conduit 2, the at least one inner conduit 3 and the plurality of hollow fibre membranes 5 provides fluid passageways through the apparatus.

A first fluid passageway 9 is provided between the outer conduit 2 and the at least one inner conduit 3. As such, in the embodiment shown in FIGS. 3 and 4, fluid can flow in the volume between the outside of the plurality of inner conduits 3 and the inside of the outer conduit 2 during use.

The membrane distillation apparatus 1 also comprises at least one second fluid passageway 10. Each second fluid passageway 10 is provided between one of the inner conduits 3 and the plurality of hollow fibre membranes 4 within that conduit 3. As such, during use fluid can flow in the volume between the outside of the plurality of hollow fibre membranes 4 and the inside of the inner conduit 3 within which the hollow fibre membranes 4 are located. In the embodiment shown in FIGS. 3 and 4, the membrane distillation apparatus 1 comprises a plurality of second fluid passageways 10 as the apparatus comprises a plurality of inner conduits 3. In embodiments where the apparatus comprises only one inner conduit 3, the membrane distillation apparatus 1 provides a single second fluid passageway 10.

A plurality of third fluid passageways 11 is provided in the membrane distillation apparatus 1. One of the plurality of third fluid passageways 11 is provided within each of the plurality of hollow fibre membranes 4 of the membrane distillation apparatus 1. As such, during use fluid can flow through the plurality of hollow fibre membranes 4.

In the membrane distillation apparatus 1, the hydrophobic material of the plurality of hollow fibre membranes 4 provides the boundary between the second fluid passageway 10 and the third fluid passageways 11 within that second fluid passageway 10. Therefore, during use of the membrane distillation apparatus 1, a vapour or a gas is able to pass between the second fluid passageways 10 and the third fluid passageways 11. Thus, the apparatus can be used to separate a vaporous permeate from or combine a gas with a fluid that is within one of the at least one second fluid passageways 10 and the plurality of third fluid passageways 11. Several examples of different uses of the membrane distillation apparatus 1 is described below.

The membrane distillation apparatus 1 comprises a plurality of inlets 12, 13, 14 and outlets 15, 16, 17 for the fluid passageways 9, 10, 11 configured to permit fluid to enter and exit the respective fluid passageways. The membrane distillation apparatus 1 comprises inlets 12, 13, 14 for the first 9, second 10 and third 11 fluid passageways, respectively, at one end of the membrane distillation apparatus 1 and outlets 15, 16, 17 for the first 9, second 10 and third 11 fluid passageways, respectively, at the other end of the membrane distillation apparatus 1. As shown in FIG. 1, the inlet 12 and the outlet 15 for the first fluid passageway 9 are formed in the outer conduit 2. The inlet 13 and the outlet 16 of the plurality of second fluid passageways 10 and the inlet 14 and the outlet 17 of the plurality of third fluid passageways 11 are formed in the second cap 7.

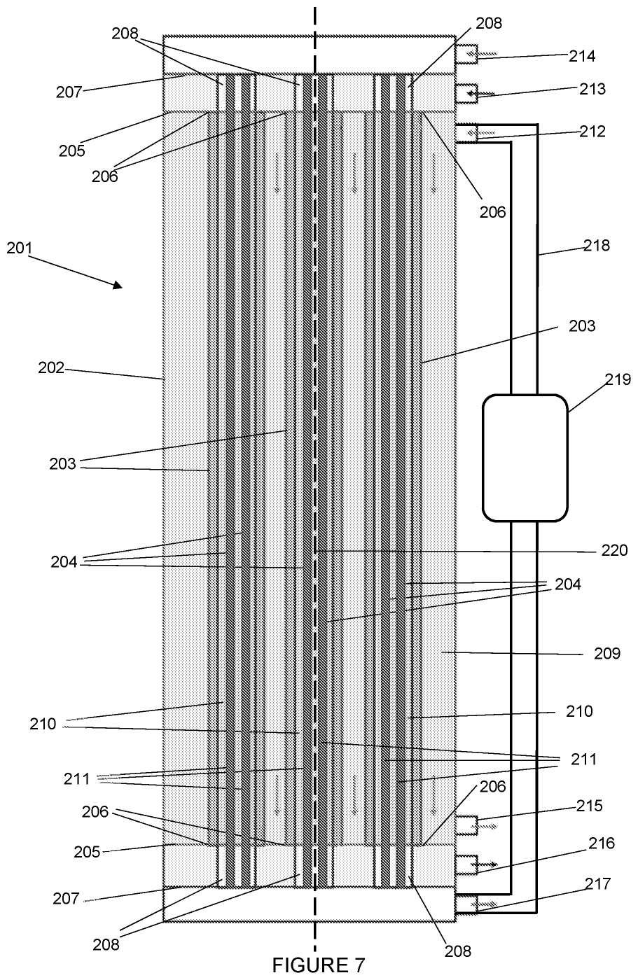

FIG. 6 shows a membrane distillation apparatus 101 according to another embodiment of the invention. The membrane distillation apparatus 101 is identical to the membrane distillation apparatus 1 of FIGS. 1 to 3 except that the membrane distillation apparatus 101 of FIG. 6 comprises an additional fluid passageway 118. Reference numerals in FIG. 6 correspond to those used in FIGS. 1 to 3 for like features but are transposed by 100.

As shown in FIG. 6, the membrane distillation apparatus 101 comprises a common fluid passageway 118 fluidly connecting the outlet 115 of the first fluid passageway 109 to the inlet 114 the plurality of third fluid passageways 111. As such, fluid exiting the first fluid passageway 109 may then enter the plurality of third fluid passageways 111 and be recirculated through the membrane distillation apparatus 101.

The common fluid passageway 118 comprises heating means 119 configured to heat fluid flowing along the common fluid passageway 118. The heating means 119 may comprise a heat exchanger or another suitable apparatus. Thus, fluid exiting the first fluid passageway 109 may be heated prior to entering the plurality of third fluid passageways 111.

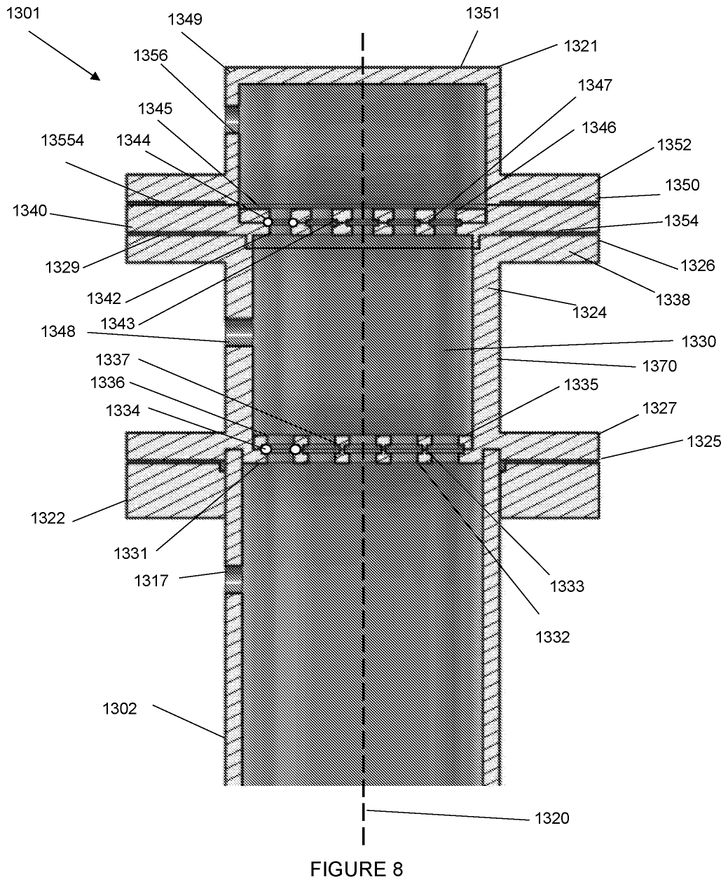

FIG. 7 shows an apparatus 201 according to another embodiment of the invention. The apparatus 201 is identical to the membrane distillation apparatus 1 of FIGS. 1 to 3 except that the apparatus 201 of FIG. 7 comprises an additional fluid passageway 218. Reference numerals in FIG. 7 correspond to those used in FIGS. 1 to 3 for like features but are transposed by 200.

In a similar manner to the embodiment shown in FIG. 6, the apparatus 201 comprises a common fluid passageway 218. However, in the embodiment of FIG. 7, the outlet 217 of each the plurality of third fluid passageways 211 is fluidly connected to the inlet 212 of the first fluid passageway 209 via the common fluid passageway 218. As such, fluid exiting the plurality of third fluid passageways 211 may enter the first fluid passageway 209 and be recirculated through the apparatus 201.

The common fluid passageway 218 may comprise recirculation means 219 for driving the recirculation of fluid from the plurality of third fluid passageways 211 into the first fluid passageway 209 and for increasing the temperature and pressure of the fluid. The recirculation means 219 may comprise a vacuum pump, a fan or a compressor.

The membrane distillation apparatuses of FIGS. 1 to 5 may be used in the step of distilling the above-described mineral-rich solution 80 according to the two methods described below. The arrows shown in FIGS. 1, 2, 4 and 5 illustrate the direction of fluid flow within each apparatus during the different methods.

According to a first method, the mineral-rich solution may be distilled by providing a membrane distillation apparatus 1, 101 according to the embodiments shown in FIGS. 3 and 4 or in FIG. 6 and feeding the mineral-rich solution through the plurality of third fluid passageways 11, 111. Feeding the mineral-rich solution through the plurality of third fluid passageways 11, 111 may comprise feeding the mineral-rich solution at a pressure that is less than the liquid entry pressure of the hydrophobic material of the plurality of the hollow fibre membranes 4, 104. The liquid entry pressure for the hollow fibre membranes 4, 104 is the pressure threshold which, when exceeded, the hydrophobic properties of the hollow fibre membranes 4, 104 are overcome. The liquid entry pressure may vary with the pore sizes of the hollow fibre membranes 4, 104, the number of hollow fibre membranes 1, 104 within each inner conduit 3, 103 and the diameters of the hollow fibre membranes 4, 104. In certain embodiments, the liquid entry pressure may be between 1 bar and 4 bar.

During the first method, the vapour pressure in the plurality of third fluid passageways 11, 111 is greater than the vapour pressure in the plurality of second fluid passageways 10, 110 of the apparatuses 1, 101 of FIGS. 1, 2 and 4. This difference in vapor pressure drives a vaporous permeate of the mineral-rich solution through the hydrophobic material of the plurality of hollow fibre membranes 4, 104 into the plurality of second fluid passageways 10, 110. The permeate is therefore separated from the mineral-rich solution by membrane distillation. The difference in vapour pressure between the plurality of third fluid passageways 11, 111 and the plurality of second fluid passageways 10, 110 may be created by one or more of a temperature gradient, concentration gradient, applying a vacuum to the plurality of second fluid passageways or by another suitable method.

Once the permeate enters the plurality of second fluid passageways 10, 110, it is subsequently extracted from the plurality of second fluid passageways 10, 110. The permeate is extracted through the outlet 16, 116 of the plurality of second fluid passageways 10, 110. The extracted permeate can be condensed and used to rinse the crystallised compounds of the mineral as described above.

In certain embodiments, the first method may comprise feeding a coolant through the first fluid passageway 9, 109 where the temperature of the coolant is lower than the temperature of the mineral-rich solution. The coolant may enable at least part of the permeate of the mineral-rich solution to condense in the plurality of second fluid passageways 10, 110. The permeate may condense on the plurality of inner conduits 3, 103. In certain embodiments, the coolant may comprise the solution before it has been heated by the heating means 32. Alternatively, the coolant may be a different fluid to the solution and may be cooled by alternative means.

As the mineral-rich solution passes through the plurality of third fluid passageways 11, 111 the mineral-rich solution is cooled due to heat losses from evaporation of the permeate and through conduction. When the mineral-rich solution exits the plurality of third passageways it may have cooled sufficiently to be used the coolant. As such, in certain embodiments, the mineral-rich solution which exits the plurality of third fluid passageways 11, 111 may be recirculated as a coolant through the first fluid passageway 9, 109. In such embodiments, the outlet 17, 117 of the plurality of third fluid passageways 11, 111 may be fluidly connected to the inlet 12, 112 of first fluid passageway 9, 109.

When the first method comprises providing the membrane distillation apparatus 100 of the embodiment shown in FIG. 6, the coolant may comprise the mineral-rich solution. In such embodiments, the first method comprises feeding the mineral-rich solution into the first fluid passageway 109. Then extracting the mineral-rich solution from the first fluid passageway 109 and heating it before feeding the mineral-rich solution into the plurality of third fluid passageways 112. Thus, the mineral-rich solution may flow from the first fluid passageway 109 through the common fluid passageway 118 where it is heated using the heating means 119 and then into the plurality of third fluid passageways 112. Recirculating the mineral-rich solution enables it to be pre-heated by the latent heat of condensation of the vaporous permeate. Thus, the energy required by the first method may be reduced.

The mineral-rich solution may be recirculated through the first fluid passageway 9, 109 and the plurality of third fluid passageways 11, 111 until the concentration of the mineral in the mineral-rich solution has reached a desired concentration.

Providing a coolant in the first fluid passageway 9, 109 creates a temperature gradient across each of the second fluid passageways 10, 110. In certain embodiments, this temperature gradient may create the difference in vapour pressure for driving the vaporous permeate of the mineral-rich solution into the plurality of second fluid passageways 10, 110. In alternative embodiments, the coolant may predominately facilitate condensation of the vaporous permeate within the plurality of second fluid passageways 10, 110 and the difference in vapour pressure for driving the vaporous permeate of the mineral-rich solution into the plurality of second fluid passageways 10, 110 may be provided at least in part by a concentration gradient or creating a vacuum in the plurality of second fluid passageways 10, 110.

In certain embodiments, the step of providing the membrane distillation apparatus 1, 101 may comprise providing air, a partial vacuum, a vacuum, a porous material or a liquid within the plurality of second fluid passageways 10, 110. Thus, the plurality of second fluid passageways 10, 110 may comprise (i.e. be filled with) air, a partial vacuum, a vacuum, a porous material or a liquid. The contents of the second fluid passageways 10, 110 may enable the first method to utilise different techniques for membrane distillation.

In embodiments where the plurality of second fluid passageways 10, 110 comprise air, the first method uses air gap membrane distillation. The vaporous permeate may pass through the air in the plurality of second fluid passageways 10, 110 and condense on the plurality of inner conduits 3, 103. The condensed permeate then flows downwards under gravity or by pumping towards the outlet 16, 116 of the plurality of second fluid passageways 10, 110. In such embodiments, the coolant may be fed into the first fluid passageway 9, 109 to provide a vapour pressure difference to drive the membrane distillation and to enable condensation of the permeate.

In embodiments where the plurality of second fluid passageways 10, 110 comprise a partial vacuum or a vacuum, the first method may use vacuum-assisted or vacuum membrane distillation, respectively. In such embodiments, the vacuum or partial vacuum increases the difference in vapour pressure for driving the vaporous permeate of the mineral-rich solution through the plurality of hollow fibre membranes 4, 104 into the plurality of second fluid passageways 10, 110. This may be used as an alternative to or in addition to the above-described temperature gradient provided by the coolant. The vacuum or partial vacuum causes the vaporous permeate to be drawn out of the membrane distillation apparatus 1, 101 at the outlet 16, 116 of the plurality of second fluid passageways 10, 110. The vaporous permeate may be condensed in a condenser which is separate to the membrane distillation apparatus 1, 101. Alternatively, the vaporous permeate may be condensed in the plurality of second fluid passageways 10, 110, for example, the vaporous permeate may condense on the plurality of inner conduits 3, 103.

In embodiments where the plurality of second fluid passageways 10, 110 comprise a porous material, the porous material may help to facilitate condensation of the vaporous permeate within the second fluid passageways 10, 110. Additionally, the porous material may reduce thermal losses from the plurality of third fluid passageways 11, 111 due to the coolant in the first fluid passageway 9, 109.

In embodiments where the plurality of second fluid passageways 10, 110 comprise a liquid, the first method may use osmotic distillation. In such embodiments, the plurality of second fluid passageways 10, 110 comprise a liquid that has a lower concentration of solvent than the mineral-rich solution. The concentration gradient provides the difference in vapour pressure for driving the vaporous permeate of the mineral-rich solution (i.e. the solvent) through the plurality of hollow fibre membranes 4, 104 into the plurality of second fluid passageways 10, 110. This may be used as an alternative to or in addition to the above-described temperature gradient provided by the coolant. The liquid enters the plurality of second fluid passageways 10, 110 through the inlet 13, 113 of the plurality of second fluid passageways 10, 110 and exit together with the permeate through the outlet 16, 116 of the plurality of second fluid passageways 10, 110.

Alternatively, the first method may use sweep gas membrane distillation. Non-limiting examples of the sweep gas include air and nitrogen. In such embodiments, the step of extracting the permeate of the mineral-rich solution from the plurality of second fluid passageways 10, 110 comprises feeding a sweep gas through the plurality of second fluid passageways 10, 110. The sweep gas enters the plurality of second fluid passageways 10, 110 through the inlet 13, 113 of the plurality of second fluid passageways 10, 110. The vaporous permeate is removed from the membrane distillation apparatus 1, 101 together with the sweep gas at the outlet 16, 216 of the plurality of second fluid passageways 10, 110. The vaporous permeate may then be condensed in a condenser which is separate to the membrane distillation apparatus 1, 101. In such embodiments, the coolant may be fed into the first fluid passageway 9, 109 to provide the difference in vapour pressure for driving the vaporous permeate of the mineral-rich solution into the plurality of second fluid passageways 10, 110.

According to a second method, the mineral-rich solution may be distilled by providing a membrane distillation apparatus 1, 201 according to the embodiments shown in FIGS. 1 and 2 or in FIG. 7 and feeding the mineral-rich solution through the plurality of second fluid passageways 10, 210. Feeding the mineral-rich solution through the plurality of second fluid passageways 10, 210 may comprise feeding the mineral-rich solution at a pressure that is less than the liquid entry pressure of the hydrophobic material of the plurality of the hollow fibre membranes 4, 204.

During the second method, the vapour pressure in the plurality of second fluid passageways 10, 210 is greater than the vapour pressure in the plurality of third fluid passageways 11, 211 of the apparatuses 1, 201 of FIGS. 3, 4 and 7. As described above in the first method, this difference in vapor pressure drives a vaporous permeate of the mineral-rich solution through the hydrophobic material of the plurality of hollow fibre membranes 4, 204 into the plurality of third fluid passageways 11, 211. The permeate is therefore separated from the mineral-rich solution by membrane distillation. The difference in vapor pressure between the plurality of third fluid passageways 11, 211 and the plurality of second fluid passageways 10, 210 may be created by one of more of a temperature gradient, concentration gradient, applying a vacuum or partial vacuum to the plurality of second fluid passageways or by another suitable method.

Once the permeate enters the plurality of third fluid passageways 11, 211, it is extracted from the plurality of third fluid passageways 11, 211. The permeate is extracted through the outlet 17, 217 of the plurality of third fluid passageways 11, 211. The extracted permeate can be condensed and used to rinse the crystallised compounds of the mineral as described above.

When the second method comprises providing the apparatus 200 of the embodiment shown in FIG. 7, the vaporous permeate extracted from the plurality of third fluid passageways 11, 211 may be recirculated through the apparatus 200 via the common fluid passageway 218. In such embodiments, the permeate is extracted from the plurality of third fluid passageways 11, 211 by the recirculation means 219 which increases the temperature and pressure of the permeate. The permeate is then fed into the first fluid passageway 9, 209. In the first fluid passageway 9, 209, the permeate condenses on the inner 3, 203 transferring the latent heat of condensation to the mineral-rich solution in the plurality of second fluid passageways 10, 210. Thus, reducing the energy required by the second method.

In certain embodiments, the step of providing the membrane distillation apparatus 1, 201 may comprise providing a partial vacuum, a vacuum or a liquid within the plurality of the plurality of third fluid passageways 11, 211. Thus, the plurality of third fluid passageways 11, 211 may comprise a partial vacuum, a vacuum, or a liquid. The contents of the plurality of third fluid passageways 11, 211 may enable the second method to utilise different techniques for membrane distillation.

In embodiments where the plurality of second fluid passageways 10, 210 comprise a partial vacuum or a vacuum, the second method may use vacuum-assisted or vacuum membrane distillation, respectively. The vacuum or partial vacuum increases the difference in vapour pressure for driving the vaporous permeate of the mineral-rich solution through the plurality of hollow fibre membranes 4, 204 into the plurality of second fluid passageways 10, 210. The vaporous permeate may then be recirculated through the membrane distillation apparatus 1, 201 by removing it from the plurality of third fluid passageways 11, 211 using a vacuum pump or a compressor 219 to increase its temperature and pressure and feeding the permeate into the first fluid passageway 9, 209 to condense.

Alternatively, the second method may use sweep gas membrane distillation. Non-limiting examples of the sweep gas include air and nitrogen. In such embodiments, the step of extracting the permeate of the mineral-rich solution from the plurality of third fluid passageways 11, 211 comprises feeding a sweep gas through the plurality of third fluid passageways 11, 211. The sweep gas enters the plurality of third fluid passageways 11, 211 through the inlet 14, 214 of the plurality of third fluid passageways 11, 211. The vaporous permeate is removed from the membrane distillation apparatus 1, 201 together with the sweep gas at the outlet 17, 217 the plurality of third fluid passageways 11, 211. The vaporous permeate and sweep gas may then be recirculated through the membrane distillation apparatus 1, 201. The vaporous permeate and sweep gas may be removed from the plurality of third fluid passageways 11, 211 using a fan or a compressor 219 which increases its temperature and pressure and fed into the first fluid passageway 9, 209 where the permeate condenses.

In the first and second methods according to the first and second embodiments of the invention, the mineral-rich solution and permeate may flow along the fluid passageways in the membrane distillation apparatus 1, 101, 201 at a rate from 0.5 to 10 litres per minutes and at a pressure of from 1 to 10 bar. However, the flow rates and pressures are not limited to these ranges. For example, the membrane distillation apparatus 1, 101, 201 could be used for high pressure filtration which exceeds 30 bar. Exemplary flow rates through the hollow membrane fibres 4, 104, 204 are from 1 to 40 litres per square meter per hour and will vary depending on the temperature of the mineral-rich solution, the flow rate, heat recovery and the chemistry of the mineral-rich solution. Typically, the temperature of the mineral-rich solution entering the membrane distillation apparatus 1, 101, 201 is in the range from 30 to 90° C.

When using either the first or second methods for distilling the mineral-rich solution, crystallising compounds comprising the mineral may occur within the mineral distillation apparatuses 1, 101, 201 on the surface of the plurality of hollow fibre membranes 4, 104, 204. The large surface area provided by the plurality of hollow fibre membranes 104 may help increase the speed at which the compounds are crystallised. Alternatively, the crystallisation of the compounds may occur within the bulk of the mineral-rich solution within the membrane distillation apparatus or within a separate crystallisation unit 91 as shown in FIG. 2.

The above-described apparatus 1, 101, 201 of FIGS. 5 to 8 and first and second methods may improve the efficiency of distilling the mineral-rich solution compared to other membrane distillation apparatuses and methods. Including a plurality of hollow fibre membranes within each inner conduit of the apparatus provides a large surface area through which a permeate may pass. Providing three different fluid passageways within the apparatus enable temperature regulation of fluids in the apparatus and facilitates condensation of a permeate within the apparatus. The apparatuses and methods may therefore improve the efficiency of and reduce the energy required for separating a permeate from a fluid or combining of a gas with a liquid.

Including a plurality of inner conduits within the outer conduit further improve these efficiencies and reduce the energy requirements.

In embodiments of the method 30 for extracting the mineral that include the step of increasing the concentration of the mineral in the solution 50 prior to selectively extracting the mineral from the solution 60, the concentration of the mineral may be increased using the membrane distillation apparatus 1, 101, 201 shown in FIGS. 3 to 7. That is, the concentration unit 51 may comprise the membrane distillation apparatuses 1, 101, 201 shown in FIGS. 3 to 7. In such embodiment, the heat exchanger 52 may provide the coolant for the membrane distillation apparatuses 1, 101, 201.

In any of the embodiments shown in FIGS. 3 to 7, the size of the outer conduit, inner conduit and plurality of hollow fibre membranes may be selected depending on the intended use of the apparatus.

The diameter of the outer conduit 2 may be relatively large compared to that of the inner conduits 3 in order to reduce heat loss from the outer surface of the outer conduit. In certain embodiments, the outer conduit 2 may have a diameter of approximately 110 mm. Each of the inner conduits 3 may have an outer diameter of approximately 15 mm. As shown in the embodiment of FIG. 4, the outer diameter of all inner conduits 3 in the apparatus may be the same as each other.

The outside diameter of the hollow fibre membranes may be 0.3 mm or greater or the outside diameter of the hollow fibre membranes may be from 0.3 mm to 3 mm. As described above, during use of the apparatus a fluid may flow through the plurality of third fluid passageways 11 (i.e. through the plurality of hollow fibre membranes 4). The smaller the diameter of the hollow fibre membranes 4, the larger the drop in pressure across the length of the membrane 4 that is required for fluid to flow through the membrane 4. Thus, the diameter of the hollow fibre membranes 4 will depend on the intended use of the membrane distillation apparatus 1. Hollow fibre membranes having an outside diameter of 1 mm and an inside diameter of 0.9 mm (i.e. a wall thickness of 0.05 mm) may provide sufficient surface area for the membrane whilst minimising the pressure drop.

The plurality of hollow fibre membranes 4 may have a length from 0.3 m to 4 m. The inner 3 and outer 2 conduits may have a length from 0.3 m to 4 m. The drop in pressure along the hollow fibre membranes 4 increases with the length of the membrane 4. Thus, the length of the hollow fibre membranes 4 will depend on the intended use of the membrane distillation apparatus 1. A hollow fibre membrane 4 length of 1 m may allow sufficient vapour flow through the membrane and an acceptable pressure drop along the membrane.

The volume of each inner conduit 3 which is occupied by the plurality of hollow fibre membranes 4 is selected based on the intended use of the membrane distillation apparatus 1 such as what the mineral is and the recovery rate of the mineral. The packing density of the hollow fibre membranes 4 within each inner conduit 3 provides a measure of the amount of the inner conduit 3 which is filled by the hollow fibre membranes 4. The packing density is the ratio of the surface area of the plurality of hollow fibre membranes 4 to the volume of the inner conduit 3 in which they are contained. As described above, during use of the apparatus a fluid may flow through the plurality of third fluid passageways 11 (i.e. through the plurality of hollow fibre membranes 4) and/or through the plurality of second fluid passageways 10. If the packing density of the hollow fibre membranes 4 is high, for example greater than 20,000 m²/m³ it may result in laminar flow rather than turbulent flow of the fluid. Turbulent flow improves heat transfer through the membrane distillation apparatus 1 whereas laminar flow may reduce heat transfer through the membrane distillation apparatus 1. Furthermore, if the packing density is high a greater pressure is required to drive the fluid along the plurality of second 10 or third fluid passageways 111 through the apparatus. As such, the packing density of the hollow fibre membranes within each inner conduit may be less than 20,000 m²/m³ or less than 10,000 m²/m³.

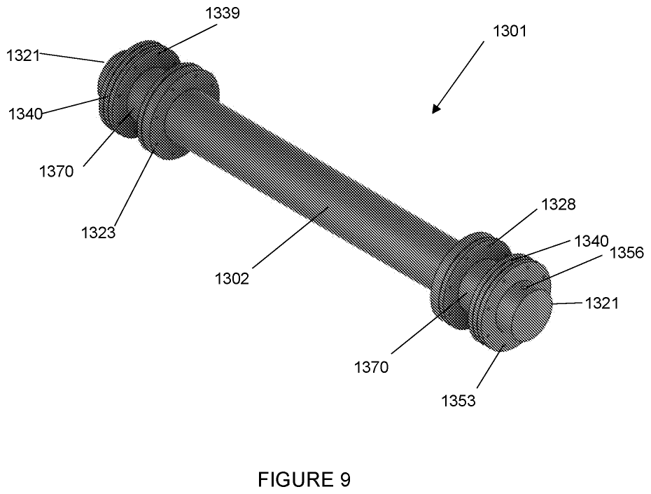

FIGS. 8 and 9 shows an apparatus 1301 according to another embodiment of the invention. The apparatus 1301 is substantially the same as the apparatus 1 of FIGS. 3 to 5 except in how the outer and inner conduits are fluidly sealed. That is, the apparatus 1301 of FIGS. 8 and 9 comprises first collar 1370, second collar 1340 and cap 1321 which differ from the first and second caps 5, 7 described for the apparatus 1 in the embodiment of FIGS. 3 to 5. The apparatus 1301 may be used in either of the embodiments shown in FIGS. 6 and 7. Thus, the apparatus 1301 may be used in combination with either of the common fluid passageways 118, 218. Reference numerals in FIGS. 8 and 9 correspond to those used in FIGS. 3 to 5 for like features but are transposed by 1300. The apparatus 1301 may be used in any of the above-described methods. The method 30 for mineral extraction may comprise providing the apparatus 1301 of FIGS. 8 and 9. The apparatus 31 for mineral extraction may comprise the apparatus 1301 of FIGS. 8 and 9.

As shown in FIG. 8, the apparatus 1301 comprises an outer conduit 1302. The outer conduit 1302 may comprise a two openings 1317 to allow fluid to enter and exit the first fluid passageway. The openings 1317 may be in the side walls of the outer conduit 1302. The outer conduit 1302 may include all features of the outer conduit 2 described in reference to the apparatus 1 in FIGS. 3 to 5. The outer conduit 1302 may additionally comprise a flange 1322 positioned at each end of the outer conduit 1302. Each flange 1322 may surround one end of the outer conduit 1302. The flange 1322 may comprise a plurality of holes 1323 extending therethrough. The holes 1323 may be configured to receive fasteners (not shown), such as a threaded fastener like a bolt or a screw. The bolt may be configured to receive a nut.

Whilst not shown, the apparatus 1301 is configured to receive a plurality of inner conduits and a plurality of hollow fibre membranes within each of the inner conduits. The apparatus 1301 is configured to receive inner conduits and hollow fibre membranes that are substantially the same and arranged in the same manner as those described in reference to the apparatus in FIGS. 3 to 5. Thus, the apparatus 1301 may provide: a first fluid passageway provided between the outer conduit 1302 and the plurality of inner conduits; a plurality of second fluid passageways provided between each of the inner conduits and the plurality of hollow fibre membranes within that conduit; and a plurality of third fluid passageways, each of the third fluid passageways being within one of hollow fibre membranes the apparatus 1301 is configured to receive.

As shown in FIGS. 8 and 9, the apparatus 1301 comprises at least one first collar 1370. The first collar 1370 may be configured to be secured to an end of the outer conduit 1302. As shown in FIG. 9, the apparatus 1301 may comprise two first collars 1370, each first collar 1370 being securable to one end of the outer conduit 1302.

The first collar 1370 may comprise a body 1324 extending from a first end 1325 to a second end 1326. The first collar 1370 may comprise a first flange 1327 to facilitate securing of the first collar 1370 to the outer conduit 1302. The first flange 1327 may be positioned at the first end 1325 of the body 1324. The first flange 1327 and the body 1324 may be formed as one piece or the first flange 1327 may be secured to the body 1324. The first flange 1327 may comprise a plurality of holes 1328 arranged to align with the holes 1323 in one of the flanges 1322 of the outer conduit 1302. The holes 1322 in the first flange 1327 may also be configured to receive fasteners (not shown). Thus, the first collar 1370 may be secured to the outer conduit 1302 by aligning the holes 1323 in the flange 1322 of the outer conduit 1302 and the holes 1328 in the first flange 1327 then inserting the fasteners through the holes 1323, 1328.

The apparatus 1301 may comprise a first gasket 1329 arranged between the flange 1322 of the outer conduit 1302 and the first flange 1327 of the first collar 1370. The first gasket 1329 may fluidly seal the outer conduit 1302 to the first collar 1370.

As shown in FIG. 8, the body 1324 of the first collar 1370 comprises a passage 1330 extending therethrough so that the inner conduits may extend into the first collar 1370 from the outer conduit 1302. As such, the first collar 1370 may have a substantially hollow interior. The passage 1330 through the first collar 1370 may be substantially cylindrical. The passage 1330 may have a diameter less than or equal to an internal diameter of the outer conduit 1302.

The first collar 1370 may comprise a fixed insert 1331 which extends across the passage 1330 of the first collar 1370. The fixed insert 1331 may be positioned at or towards the first end 1325 of the first collar 1370. The fixed insert 1331 is in a fixed in position relative to the body 1324 of the first collar 1370.

The fixed insert 1331 comprises a plurality of apertures 1332. Each aperture 1332 is configured to receive one of the inner conduits. As such, the inner conduits may extend from the outer conduit 1302 into the first collar 1370. The diameter of each aperture 1332 in the fixed insert 1331 may be the same as or larger than an outer diameter of the inner conduits. The fixed insert 1331 comprises the same number of apertures 1332 as the number of inner conduits the outer conduit 1302 is configured to receive.

The fixed insert 1331 may comprise a groove 1333 extending circumferentially around each aperture 1332 on one side of the insert 1331. The grooves 1333 may be positioned on the side of the fixed insert 1331 facing towards the second end 1326 of the body 1324. The first collar 1370 may comprise a plurality of first o-rings 1334. The grooves 1333 are configured to partially receive one of the plurality of first o-rings 1334. The first o-rings 1334 may comprise an elastomeric material. In FIG. 8, for simplicity only one of the grooves 1333 is shown as having a first o-ring 1334 residing therein. However, all grooves 1333 are configured to receive a first o-ring 1334.

The apparatus 1301 may comprise a first removable insert 1335. The first removable insert 1335 is releasably securable to the body 1324 of the first collar 1370. The first removable insert 1335 may be configured to extend across the passage 1330 of the first collar 1370. Thus, the first removable insert 1335 may have the same diameter as the diameter of the passage 1330 of the first collar 1370.

The first removable insert 1335 may comprise a plurality of apertures 1336. The apertures 1336 in the first removable insert 1335 correspond to the apertures 1332 in the fixed insert 1331. That is, apertures 1336 in the first removable insert 1335 have the same shape, size and distribution as the apertures 1332 in the fixed insert 1331. Thus, each aperture 1336 in the first removable insert 1335 is configured to receive one of the inner conduits.

The first removable insert 1335 may comprise a groove 1337 extending circumferentially around the of each aperture 1336 on one side of the insert 1334. In the same manner as the fixed insert 1331, the grooves 1337 in the first removable insert 1335 may be configured to partially receive one of the plurality of first o-rings 1334.

The fixed insert 1331 and the first removable insert 1335 comprise a plurality of holes (not shown) configured to receive fasteners (not shown). Non-limiting examples of the fasteners include as a threaded fastener such as a bolt or a screw. The bolt may be configured to receive a nut. The holes may be positioned between the apertures 1332, 1336 in each of the inserts 1331, 1335. The holes in the fixed insert 1331 and first removable insert 1335 are arranged so that the inserts 1331, 1335 may be secured together by the fasteners. FIG. 8 shows the fixed insert 1331 secured to the first removable insert 1335. The first removable insert 1335 may be secured to the fixed insert 1331 so that the grooves 1337 surrounding the apertures 1336 in the first removable insert 1335 are next to with the grooves 1333 surrounding the apertures 1332 in the fixed insert 1331. As such, each of the first o-rings 1334 may reside between within the grooves 1333, 1337 between the two inserts 1331, 1335. The axial height of the first o-rings is greater than the combined axial height of the grooves 1333, 1337 in the fixed and first removable inserts 1331, 1335. The height of the first o-rings 1334 and the grooves 1333, 1337 is in a direction parallel to the longitudinal axis 1320 shown in FIG. 8.

The fixed and first removable inserts 1331, 1335 are configured so that as the inserts 1331, 1335 are secured together the first o-rings 1334 are compressed axially. This results in radial expansion of the first o-rings 1334. As such, when the inserts 1331, 1335 are secured together the first o-rings 1334 form a fluid tight seal around inner conduits that extend through the apertures 1332, 1336. Therefore, fluid within the first fluid passageway, between the outer conduit 1302 and the plurality of inner conduits, is prevented from passing through the first collar 1370. The first collar 1370 may therefore fluidly seal the ends of the outer conduit 1302.

At the second end 1326 of the body 1324, the first collar 1370 may comprise a second flange 1338. In the same manner as the first flange 1327 of the first collar 1370, the second flange 1338 comprises a plurality of holes 1339 configured to receive fasteners. The second flange 1338 and the body 1324 may be formed as one piece or the second flange 1338 may be secured to the body 1324.

As shown in FIG. 8, the apparatus 1301 may comprise at least one second collar 1340. As shown in FIG. 9, the apparatus 1301 may comprise two second collars 1340, each second collar 1340 being securable one of the first collars 1370. The second collar 1340 is configured to be secured to the second flange 1338 of the first collar 1370. As such, the second collar 1340 may comprise a plurality of holes (not shown) which correspond to the holes 1339 in the second flange 1338 of the first collar 1324 so that the second collar 1340 and the second flange 1338 may be secured together by a plurality of fasteners (not shown), such as a threaded fastener like a bolt or a screw. The bolt may be configured to receive a nut.

The second collar 1340 is arranged to cover the passage 1330 in the first collar 1324. The second collar 1340 comprises a plurality of apertures 1342. As described above, a plurality of hollow fibre membranes is within each of the inner conduits. Each aperture 1342 in the second collar 1340 is configured to receive the plurality of hollow fibre membranes from one of the inner conduits. As such, plurality of hollow fibre membranes extend from the first collar 1370 through the second collar 1340. However, the inner conduits do not pass through the second collar 1340. The apertures 1342 in the second collar 1340 may have a smaller diameter that the outer diameter of the inner conduits. When the apparatus 1301 is assembled, the inner conduits pass through the apertures 1332, 1336 in the fixed and first removable inserts 1331, 1335 of first collar 1370 into the passage 1330 in the first collar 1370. The inner conduits end within the first collar 1370. The plurality of hollow fibre membranes extend from the end of their respective inner conduit and pass through the second collar 1340.

Each of the plurality of inner conduits comprises a plurality of hollow fibre membranes disposed therein. Thus, each of the plurality of inner conduits comprises a bundle of hollow fibre membranes. The plurality of hollow fibre membranes in each bundle may be secured together by a support (not shown). The support may hold the plurality of hollow fibre membranes in each bundle in a fixed position relative to one another.

The support may comprise a solid cylinder having a plurality of apertures through which the plurality of hollow fibre membranes extend. The support may comprise a potting material to fixedly hold the plurality of hollow fibre membranes relative to one another. Alternatively, the hollow fibre membranes may be secured within the apertures by a potting material. The potting materials may comprise any suitable material for fixing the plurality of hollow fibre membranes in place. Suitable potting materials include but are not limited to epoxy, polyurethane and silicone adhesives.

The support may be positioned on the plurality of hollow fibre membranes so that the support resides in the apertures 1342 of the second collar 1340 when the plurality of hollow fibre membranes are positioned within the inner conduits in the apparatus 1301. Thus, the diameter of the apertures 1342 in the second collar 1340 may be the same as or larger than the outer diameter of the support.

The second collar 1340 may comprise a groove 1343 extending circumferentially around each aperture 1342 on one side of the second collar 1340. The apparatus 1301 may comprise a plurality of second o-rings 1344. In a similar manner to the fixed and first removable inserts 1331, 1335 of the first collar 1324, the grooves 1343 in the second collar 1340 are configured to partially receive one of the plurality of second o-rings 1344. The second o-rings 1344 may comprise an elastomeric material. In FIG. 8, for simplicity only one of the grooves 1343 is shown as comprising a second o-ring 1344. However, all grooves 1343 are configured to receive a second o-ring 1344.

The apparatus 1301 may comprise a second removable insert 1345. The second removable insert 1345 is releasably securable to the second collar 1340. The second removable insert 1345 may be arranged to cover the passage 1330 in the first collar 1370. The second removable insert 1345 comprises a plurality of apertures 1346. Each aperture 1346 is configured to receive the plurality of hollow fibre membranes from one of the inner conduits. In particular, the apertures 1346 in the second removable insert 1345 are configured to receive the support of the plurality of hollow fibre membranes from one of the inner conduits. The apertures 1346 in the second removable insert 1345 correspond to the apertures 1342 in the second collar 1340. That is, apertures 1346 in the second removable insert 1345 have the same shape, size and distribution as the apertures 1342 in the second collar 1340.

The second removable insert 1345 may comprise a groove 1347 extending circumferentially around the of each aperture 1346 on one side of the insert 1345. In the same manner as the second collar 1340, the grooves 1347 in the second removable insert 1345 are configured to receive one of the plurality of second o-rings 1344.

The second collar 1340 and second removable insert 1345 comprise a plurality of holes (not shown) configured to receive fasteners (not shown). Non-limiting examples of the fasteners include as a threaded fastener such as a bolt or a screw. The holes may be positioned between the apertures 1342, 1346 in each of the second collar 1340 and the insert 1345. The holes in the second collar 1340 and the second removable insert 1345 are arranged so that the second collar 1340 and the insert 1345 may be secured together by fasteners. FIG. 8 shows the second removable insert 1345 secured to the second collar 1340. The second removable insert 1345 is secured to the second collar 1340 so that the grooves 1347 surrounding the apertures 1346 in the second removable insert 1345 are next to with the grooves 1343 surrounding the apertures 1342 in the second collar 1340. As such, each second o-ring 1344 may reside between within the grooves 1343, 1347 between the second collar 1340 and the second removable insert 1345. The axial height of the second o-rings 1344 is greater than the combined axial height of the grooves 1342, 1346 in the second collar 1340 and second removable insert 1345. The height of the second o-rings 1344 and the grooves 1342, 1346 is in a direction parallel to the longitudinal axis 1320 shown in FIG. 8.

The second collar 1340 and second removable insert 1345 are configured so that when they are secured together the plurality of o-rings second 1344 are compressed axially. This results in radial expansion of the second o-rings 1344. As such, the second o-rings 1344 provide a fluid tight seal around support of each of the plurality of hollow fibre membranes that extend through the apertures 1342, 1346. Therefore, fluid within the second fluid passageways, between each of the inner conduits and the plurality of hollow fibre membranes within the conduit, is prevented from passing through the second collar 1340. The second collar 1340 may therefore fluidly seal the ends of the inner conduits. The first collar 1370 may comprise an opening 1348 to allow fluid to enter and exit the second fluid passageways. As shown in FIG. 8, the opening 1348 may be in a side wall of the first collar 1370.

As shown in FIGS. 8 and 9, the apparatus 1301 may comprise at least one cap 1321. As shown in FIG. 9, the apparatus 1301 may comprise two caps 1321, each cap 1321 being securable one of the second collars 1340. The cap 1321 may comprise body 1349 having first open end 1350 and a second closed end 1351.

The cap 1321 is configured to be secured to the second collar 1340. The cap 1321 may comprise flange 1352 to secure the cap 1321 to the second collar 1340. The flange 1352 may be at the first end 1350 of the cap 1321. The flange 1352 of the cap 1321 may comprise a plurality of holes 1353 which correspond to those in the second collar 1340 and in the second flange 1338 of the first collar 1370 so that the cap 1321, the second collar 1340 and the first collar 1370 may be secured together as shown in FIG. 9. The cap 1321, the second collar 1340 and the second flange 1338 of the first collar 1370 may be secured together by a plurality of fasteners (not shown). The fasteners may comprise threaded fasteners, such as a bolt or a screw. The bolt may be configured to receive a nut. In alternative embodiments, cap 1321, the second collar 1340 and the first collar 1370 may be configured such that cap 1321 and the second collar 1340 are secured to each other by one set of fasteners and the first collar 1370 and the second collar 1340 are secured to each other by a different set of fasteners.

The apparatus 1301 may comprise a second and a third gasket 1354, 1355. The second gasket 1354 maybe arranged between the second flange 1338 of the first collar 1370 and the second collar 1340. The third gasket 1355 may be arranged between the second collar 1340 and the flange 1352 of the cap 1321. The second and third gaskets 1354, 1355 may fluidly seal the first collar 1370 to the second collar 1340 and the second collar 1340 to the cap 1321, respectively.

The cap 1321 is configured to receive the plurality of hollow fibre membranes. That is, when the hollow fibre membranes are within the apparatus 1301, they extend through the first collar 1370 and through the second collar 1340 into the cap 1321. Thus, fluid may pass between interior of the cap 1321 and third fluid passageways within the hollow fibre membranes. However, the first and second plurality of o-rings 1334, 1344 fluidly seal the inner conduits and the outer conduit 1302 from the cap 1321. Thus, the cap 1321 is fluidly isolated from the first fluid passageway and the second fluid passageways. The cap 1321 may comprise an opening 1356 to allow fluid to enter and exit the third fluid passageways. As shown in FIG. 8, the opening 1356 may be formed in a side wall of the cap 1321.

Whilst FIG. 8 shows one end of the apparatus 1301, each of end of the apparatus 1301 may be identical as shown in FIG. 9. That is, each end of the apparatus 1301 may comprise an first collar 1370, a second collar 1340 and an cap 1321.

To assemble the apparatus 1301 of FIGS. 8 and 9, a plurality of hollow fibre membranes are placed within each inner conduit. The support may be provided either before or after the hollow fibre membranes are placed in the inner conduits. The inner conduits enclosing the plurality of hollow fibre membranes are then placed within the outer conduit 1302. The inner conduits are configured to extend out of each end of the outer conduit 1302 and the hollow fibre membranes are configured to extend out of each end of their inner conduits.

A removable jig may be used to keep the inner conduits and hollow fibre membranes in the correct position at one of the outer conduit 1302 whilst the first collar 1370, the second collar 1340 and the cap 1321 are attached to the other end of the outer conduit 1302.

To secure the first collar 1370 to the outer conduit 1302, the first collar 1370 is placed over the inner conduits so that the inner conduits extend through the apertures 1332 in the fixed insert 1331 of the first collar 1370. The first collar 1370 may be secured to the outer conduit 1302 via fasteners extending through the holes 1323, 1328 in the first flange 1327 of the first collar 1370 and the flange 1322 of the outer conduit 1302. The plurality of first o-rings 1334 may be located into the grooves 1333 in the fixed insert 1331 of the first collar 1321.

The first removable insert 1335 may then be placed onto the inner conduits and secured to the fixed insert 1331 of the first collar 1321. As the first removable insert 1335 is secured to the fixed insert 1331, the plurality of first o-rings 1334 are compressed between the inserts 1331, 1335 to provide a fluid tight seal around the inner conduits.

The second collar 1340 may then be placed on the first collar 1370 so that the plurality of hollow fibre membranes extend through the apertures 1342 in the second collar 1340. The second collar 1340 may be positioned so that the supports on the plurality of hollow fibre membranes reside within the apertures 1342 in the second collar 1340. The plurality of second o-rings 1344 may be located into the grooves 1343 in the second collar 1340.

The second removable insert 1345 may then be placed over the plurality of hollow fibre membranes so that the membranes extend through the apertures 1346 in the second removable insert 1345. The second removable insert 1345 may be secured to the second collar 1340 causing the second plurality of o-rings 1344 to be compressed between the insert 1345 and the second collar 1340 thereby providing a fluid tight seal around the supports and the hollow fibre membranes.

The end cap 1321 may then be located on the second collar 1340. The end cap 1321, second collar 1340 and first collar 1370 may then be secured together. Thus, the first collar 1370, cap 1321 and the second collar 1340 are secured to one end of the outer conduit. The removable jig may then be removed from the other end of the outer conduit 1302 and the process may be repeated.

The features of the apparatus 1301 shown in FIGS. 8 and 9, may improve ease of assembly and dismantling of the apparatus 1301 compared to, for example, an apparatus in which the membranes and/or inner conduits are secured within the apparatus by welding or an adhesive. This may enable greater ease of replacing the membranes in the apparatus and cleaning the apparatus. As such, the entirety of the apparatus 1301 does not need to be replaced when the membranes need replacing.

The skilled person would understand that various modifications can be made to the above described membrane distillation apparatuses 1, 101, 201, 1301.

In the above described embodiments, the membrane distillation apparatus comprises a plurality of inner conduits. In alternative embodiments, the membrane distillation apparatus may comprise a single inner conduit and a single second fluid passageway. The method of the first, second and third embodiment may also comprise proving a membrane distillation apparatus comparing a single inner conduit and a single second fluid passageway.

In the membrane distillation apparatus shown in the Figures, there is one inlet and one outlet of all the plurality of second fluid passageways and one inlet and one outlet for all of the plurality of third fluid passageways. In alternative embodiments, there may be a different number of inlets and outlets. For example, each of the second and/or third fluid passageways may have an individual inlet and an individual outlet.

In certain embodiments, more than one membrane distillation apparatus may be provided in each of the above described methods. For example, the methods may comprise a plurality of apparatuses as shown in the embodiments of FIGS. 3 to 9 connected together in series or in parallel. When a plurality of membrane distillation apparatuses of the embodiment shown in FIG. 3 are connected in series, the apparatuses may be connected such that the mineral-rich solution is recirculated through all the apparatuses. For example, the outlet of the plurality of third fluid passageways of the last apparatus in the series may be fluidly connected to the inlet of the first fluid passageway of the first apparatus in the series. As such, the mineral-rich solution may flow through the plurality of third fluid passageways of each apparatus in the series before being recirculated as a coolant through the first fluid passageway of each apparatus in the series. Additionally or alternatively, the outlet of the first fluid passageway of the last apparatus in the series may be fluidly connected to the inlet of the plurality of first fluid passageways in the series. As such, the coolant may flow through the first fluid passageway of each apparatus in the series before being recirculated as the mineral-rich solution through the plurality of third fluid passageways of each apparatus in the series. The coolant may be heated prior to being recirculated as the mineral-rich solution. The mineral-rich solution may be recirculated through the series of apparatuses until the concentration of the mineral in the mineral-rich solution has reached a desired concentration.

In the above-described method and apparatus, one mineral is extracted from the solution. However, the method may be modified so that more than one mineral is extracted from the solution. In certain embodiments, a first mineral and a second mineral may be extracted from the solution. In such embodiments, the method may comprise providing the solution comprising the plurality of solutes and then selectively extracting a first mineral from the solution by adsorption to provide a first mineral-rich solution and selectively extracting a second mineral from the solution by adsorption to provide a second mineral-rich solution. Each of the first and second mineral-rich solutions may then be separately distilled by membrane distillation to increase the concentration of the mineral in each mineral-rich solution. Finally, the method may comprise removing the first mineral from the first mineral-rich solution and removing the second mineral from the second mineral-rich solution. The steps of selective extraction, distillation and removal of each of the minerals may each be performed using the same steps described above for the mineral of the embodiment of the method shown in FIG. 1. Furthermore, the method may comprise increasing the concentration of the first and second minerals in the solution prior to selectively extracting the first and second minerals from the solution and/or polishing each of the mineral-rich solutions as described above for the mineral of the embodiment of the method shown in FIG. 1. The apparatus of FIG. 2 may be similarly modified to enable extraction of two minerals from the solution. The apparatus may comprise separate means for selectively extracting a first and a second mineral from the solution by adsorption to provide a first and a second mineral-rich solution. For example, the apparatus may comprise a first set of adsorption columns and a second set of adsorption columns. The apparatus may be configured such that the solution flows through the first set of adsorption columns and then flows through the second set of adsorption columns during use. The apparatus may comprise a first membrane distillation apparatus for the first mineral and a second membrane distillation apparatus for the second mineral. The apparatus may comprise separate means for removing the first and the second mineral from the distilled each mineral-rich solution. The means for selective extraction and removal of each mineral may be the same as those described above for the apparatus in the embodiment shown in FIG. 2.

### Examples

### Adsorption Tests

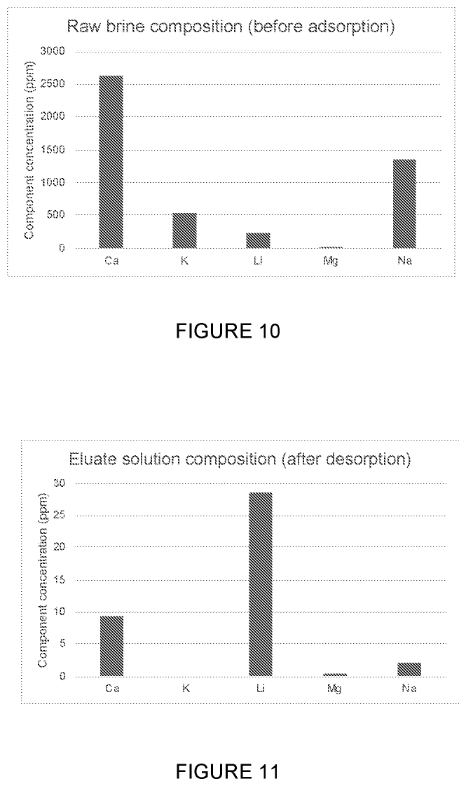

FIGS. 10 and 11 shows data from an example of selectively extracting lithium from a brine using adsorption with an ion sieve material. The ion sieve material was a titanium-based lithium ion sieve (HTO) based on Li₂TiO₃ (LTO) precursor.

To prepare titanium based lithium ion sieve a 2:1 molar ratio (2 g in total) of lithium carbonate and titanium dioxide was dispersed in 50 ml of ethanol and stirred. After 30 minutes of mixing, the mixture was poured into a petri dish and dried at 80° C. Once dried, the resulting powder was calcined at 700° C. in an electric furnace with a graphite crucible for 4 hours and allowed to cool naturally afterwards. The prepared LTO precursor was then dispersed in 50 ml of a 0.5 M hydrochloric acid (HCl) solution to replace the lithium ions with protons, resulting in the finished HTO ion sieve material.

Adsorption tests were performed using the HTO ion sieve material with a sample of raw brine. The adsorption tests comprised mixing the HTO ion sieve material with brine samples and stirring them for 24 hours at room temperature. After this, the mixture was filtered with a 0.22 μm Polyvinylidene fluoride (PVDF) membrane filter to separate the powder. The powder was rinsed with DI water to remove residual ions. The powder was then treated in a 0.2 or 0.5 M solution of HCl to release the adsorbed species. FIG. 10 shows the concentrations of different mineral components in the raw brine and FIG. 11 shows the concentrations of the same mineral components after desorption of the lithium from the HTO ion sieve material. By comparing FIG. 10 and FIG. 11 shows that selective lithium extraction from the raw brine has been achieved. Water composition analysis was conducted using ICP-AES.

### Membrane Distillation Tests

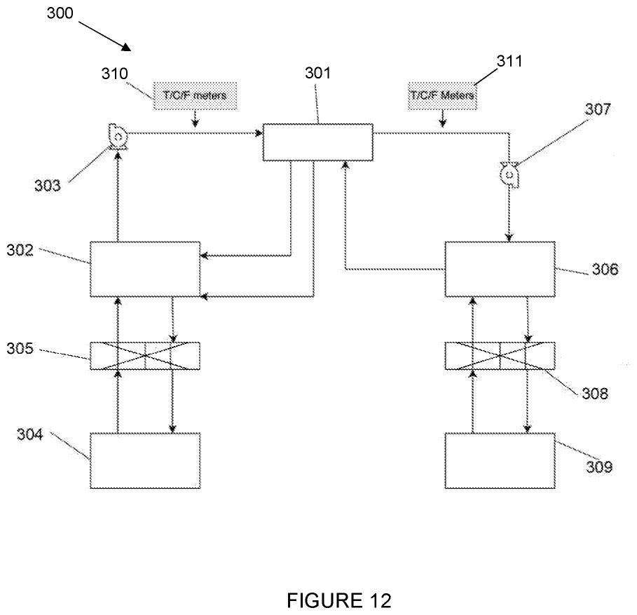

Membrane distillation experiments were conducted using an apparatus 300 shown in FIG. 12 in a 40-day continuous test. The membrane distillation experiments were conducted using raw brine investigate the performance of increasing the concentration of a solution using membrane distillation and subsequently crystallising compounds. The experiments also investigated changes in pH of the brine during the distillation. In the experiments, the raw brine did not undergo selective mineral extraction to increase the mineral concentration by adsorption prior to distillation.

The apparatus 300 includes a Perspex flat sheet membrane module 301 with a membrane area of 0.029 m². The air-gap configuration was chosen for the membrane module 301. A first side of the membrane module 301 is fluidly connected to a crystalliser vessel 302. The apparatus 300 includes a first centrifugal pump 303 for transferring fluid from the crystalliser vessel 302 to the membrane module 301. The apparatus 300 includes a water heater 304 coupled to the crystalliser vessel 302 via a first heat exchanger 305. A second side of the membrane module 301 is fluidly connected to a coolant tank 306. The apparatus 300 includes a second centrifugal pump 307 for transferring fluid from the membrane module 301 to the coolant tank 306. The apparatus 300 includes a chiller 308 coupled to the coolant tank 306 via a second heat exchanger 309. The apparatus also comprises first 310 and second 311 meters configured to measure temperature, conductivity and flow of the fluid entering the first side and exiting the second side of the membrane apparatus 301, respectively.

During the test, the raw brine was feed from a shallow aquifer and the coolant in the cool in the coolant tank 306 was tap water. Their temperatures were maintained by the first and second heat exchanges 305, 309 at 70° C. and 20° C., respectively. As shown in FIG. 12, the permeate of the raw brine extracted in the membrane module was recirculated back into the feed vessel and samples were collected and analysed with a conductivity and PH meter. Later in the test, the permeate was removed and stored in external vessels (not shown) so as to concentrate the brine within the apparatus 300. The total of brine fed into the apparatus 300 was 40 litres. The final volume of concentrated brine after the permeate was removed and stored in the external vessels was approximately 2 litres which was the minimum possible volume to reduce the brine to.

In the 2 litres of concentrated brine, precipitation of lithium carbonate was achieved by a three-step process. The first step was evaporating the brine until NaCl began to precipitate out. This was achieved by heating the brine in a beaker placed on a hotplate and stirring with a magnetic stirrer. Once crystal formation was observed, the solution was filtered through filter paper. The next step was adding a suspension calcium hydroxide in water (so-called milk of lime) to the filtered solution. This removed some magnesium in the form of magnesium hydroxide and sulfates in the form of calcium sulfate. These precipitates were then removed again by filtering through filter paper. The third step was to add sodium oxalate for further calcium removal and finally, sodium carbonate was added to precipitate lithium carbonate.

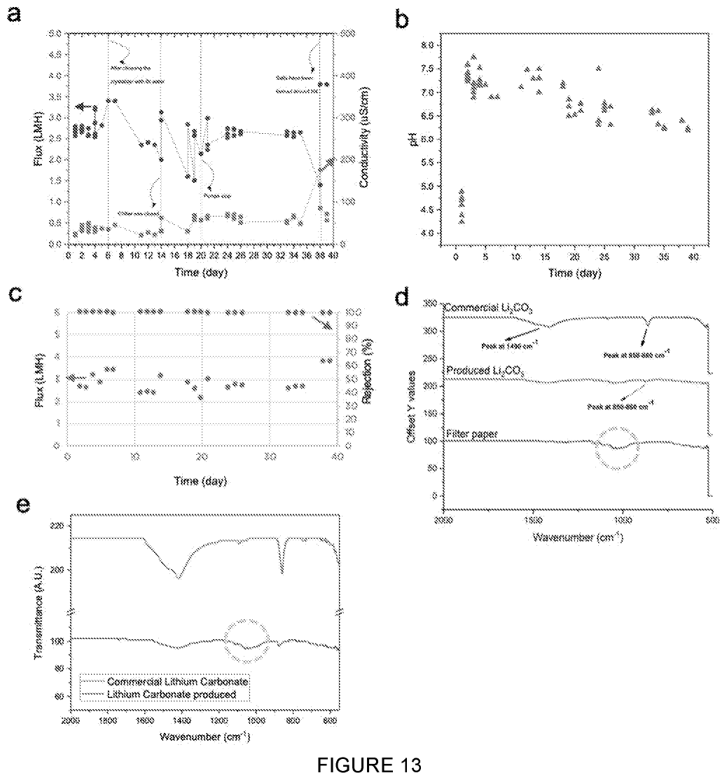

The results of the pilot experiments are shown in FIG. 13. FIGS. 13(a-c) show the flux, permeate conductivity and pH and salt rejection values from the 40-day test. Throughout the test, flux values fluctuated between 1.5 and 3.8 LMH, with an average value of 2.8 LMH. Meanwhile, permeate conductivity values varied from 22 and 85 μS/cm. However, subsequent values reduced to ˜80 μS/cm suggesting the membrane had not fouled irreversibly during the test. These conductivity values corresponded to salt rejection values of between 99.3 and 99.9%. A gradual decline in permeate pH was observed over the course of the experiment and was attributed to the slight acidity of distilled water (caused by uptake of atmospheric carbon dioxide and subsequent formation of carbonic acid). The minimum pH value measured was 6.2 but the pH of distilled water can be as low as 5.5 when in contact with air. FIGS. 13(d) & (e) show the Fourier-transform infrared (FTIR) spectra of commercial lithium carbonate, lithium carbonate produced from precipitation experiments (on filter paper) and unused filter paper for comparison. Characteristic peaks at 850-860 cm⁻¹ are observed in the two lithium carbonate samples as well as a broad split-band at ˜1490 cm⁻¹. An additional broad hump centred around 1050 cm⁻¹ is present in the produced lithium carbonate spectrum and unused filter paper spectrum (highlighted with amber circles) but not present in the commercial lithium carbonate. This is attributed to the fact that measurements were taken with the sample on top of the filter paper that it was filtered with (due to difficulty in removing the small quantity of precipitate that was produced). The results demonstrate the capability of membrane distillation for concentrating lithium-rich geothermal brine by a factor of ˜20 with stable flux values, high permeate quality and high salt rejection of 99.3 to 99.9%.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method for mineral extraction comprising:
providing a solution comprising a plurality of solutes;
selectively extracting a first mineral from the solution by adsorption to provide a first mineral-rich solution, wherein the first mineral-rich solution comprises the first mineral;
distilling the first mineral-rich solution by membrane distillation to increase the concentration of the first mineral in the first mineral-rich solution; and
subsequently removing the first mineral from the first mineral-rich solution.

2. A method according to claim 1, comprising increasing the concentration of the first mineral in the solution prior to selectively extracting the first mineral from the solution, optionally wherein the step of increasing the concentration of the first mineral in the solution prior to selectively extracting the first mineral comprises increasing the concentration of the first mineral in the solution by membrane distillation.

3. (canceled)

4. A method according to claim 1, wherein the step of selectively extracting the first mineral comprises adsorbing the first mineral from the solution onto material with selective affinity for the first mineral and applying an acidic solution to the material to desorb the first mineral by ion-exchange thereby providing the first mineral-rich solution, optionally comprising rinsing material with selective affinity for the first mineral with water after adsorption of the first mineral onto the material and prior to desorption of the first mineral.

5. (canceled)

6. A method according to claim 1, comprising increasing the concentration of the first mineral in the solution prior to selectively extracting the first mineral from the solution;
comprising rinsing material with selective affinity for the first mineral with water after adsorption of the first mineral onto the material and prior to desorption of the first mineral;
wherein the water comprises water extracted from the solution in the step of increasing the concentration of first mineral in the solution.

7. A method according to claim 1, wherein the step of removing the first mineral from the first mineral-rich solution comprises crystallising compounds comprising the first mineral and collecting the crystallised compounds.

8. A method according to claim 7, comprising rinsing the crystallised compounds using water removed from the first mineral-rich solution in the step of distilling the first mineral-rich solution by membrane distillation.

9. A method according to claim 7, comprising recovering enthalpy of crystallisation using a heat exchanger.

10. A method according to claim 7, wherein crystallising the compounds occurs on a surface of a membrane used for membrane distillation and wherein the membrane is configured to initiate nucleation of crystals.

11. A method according to claim 1, comprising adding seed crystals, non-solvents or precipitants to encourage crystallisation of the compounds within the first mineral-rich solution or the method may comprise using temperature control to encourage crystallisation of the compounds within the first mineral-rich-solution.

12. A method according to claim 1, wherein the step of distilling the first mineral-rich solution by membrane distillation to increase the concentration of the first mineral in the first mineral-rich solution comprises concentrating the first mineral-rich solution to a supersaturated state.

13. A method according to claim 1, wherein the step of providing the solution comprises heating the solution to a temperature from 20 to 90° C.

14. A method according to claim 1, comprising polishing the first mineral-rich solution to remove other solutes prior to membrane distillation, optionally wherein the step of polishing comprises adding a precipitate to the change the pH of the first mineral-rich solution or wherein the step of polishing comprises ion exchange or precipitation.

15. (canceled)

16. A method according to claim 1, wherein the step of distilling the first mineral-rich solution by membrane distillation comprises providing membrane distillation apparatus comprising:
an outer conduit;
at least one inner conduit disposed within the outer conduit; and
a plurality of hollow fibre membranes disposed within the at least one inner conduit;
wherein a first fluid passageway is provided between the outer conduit and the at least one inner conduit; at least one second fluid passageway is provided between the at least one inner conduit and the plurality of hollow fibre membranes; and a plurality of third fluid passageways are provided within the plurality of hollow fibre membranes;
wherein each of the plurality of the hollow fibre membranes comprises a hydrophobic material through which vapour and gas is passable such that, during use, a vaporous permeate is separable from a fluid that is within one of the at least one second fluid passageway and the plurality of third fluid passageways; and
wherein the step of distilling the first mineral-rich solution by membrane distillation comprises distilling the first mineral-rich solution using the membrane distillation apparatus, optionally wherein the step of distilling the first mineral-rich solution comprises feeding the first mineral-rich solution through the plurality of third fluid passageways; and
extracting a permeate of the first mineral-rich solution from the at least one second fluid passageway;
wherein the vapour pressure in the plurality of third fluid passageways is greater than the vapour pressure in the at least one second fluid passageway, or optionally
wherein the step of distilling the first mineral-rich solution comprises feeding the first mineral-rich solution through the at least one second fluid passageway; and
extracting a permeate of the first mineral-rich solution from the plurality of third fluid passageways;
wherein the vapour pressure in the at least one second fluid passageway is greater than the vapour pressure in the plurality of third fluid passageways.

17.-18. (canceled)

19. A method according to claim 1 comprising:
selectively extracting a second mineral from the solution by adsorption to provide a second mineral-rich solution;
distilling the second mineral-rich solution by membrane distillation to increase the concentration of the second mineral in the second mineral-rich solution; and
subsequently removing the second mineral from the second mineral-rich solution.

20. An apparatus for mineral extraction comprising:
means for selectively extracting a first mineral from a solution by adsorption to provide a first mineral-rich solution, wherein the solution comprises a plurality of solutes;
means for distilling the first mineral-rich solution by membrane distillation to increase the concentration of the first mineral in the first mineral-rich solution; and
means for removing the first mineral from the distilled first mineral-rich solution.

21. The apparatus of claim 20, wherein means for distilling the first mineral-rich solution by membrane distillation comprises a membrane distillation apparatus comprising:
an outer conduit;
at least one inner conduit disposed within the outer conduit; and
a plurality of hollow fibre membranes disposed within the at least one inner conduit;
wherein a first fluid passageway is provided between the outer conduit and the at least one inner conduit; at least one second fluid passageway is provided between the at least one inner conduit and the plurality of hollow fibre membranes; and a plurality of third fluid passageways are provided within the plurality of hollow fibre membranes;
wherein each of the plurality of the hollow fibre membranes comprises a hydrophobic material through which vapour and gas is passable such that, during use, a vaporous permeate is separable from or a gas is combinable with a fluid that is within one of the at least one second fluid passageway and the plurality of third fluid passageways, or wherein means for selectively extracting the first mineral from a solution by adsorption comprises at least one adsorption column comprising a material with selective affinity for the first mineral.

22. (canceled)

23. An apparatus according to claim 20, comprising means for polishing the first mineral-rich solution to remove other solutes, or comprising:
means for selectively extracting a second mineral from the solution by adsorption to provide a second mineral-rich solution;
means for distilling the second mineral-rich solution by membrane distillation to increase the concentration of the second mineral in the second mineral-rich solution; and
means for removing the second mineral from the distilled second mineral-rich solution.

24. An apparatus according to claim 20, wherein a surface of the plurality of hollow fibre membranes are configured to initiate nucleation of crystals.

25. (canceled)

26. A method of claim 1, wherein the first mineral is an alkali metal, an alkali earth metal, a transition metal, a rare earth element or an organic compound, or wherein the first mineral is lithium, potassium, calcium or magnesium.

27. An apparatus of claim 20, wherein the first mineral is an alkali metal, an alkali earth metal, a transition metal, a rare earth element or an organic compound, or wherein the first mineral is lithium, potassium, calcium or magnesium.
